(19) United States
(12) Patent Application Publication
(10) Pub. No.: US 2016/0183351 A1
(43) Pub. Date: Jun. 23, 2016

(54) SYSTEM, METHOD, AND APPARATUS FOR POWERING INTELLIGENT LIGHTING NETWORKS

(71) Applicant: IDS-IP HOLDINGS LLC, CEDAR RAPIDS, IA (US)

(72) Inventors: DAVID M. SNYDER, CEDAR RAPIDS, IA (US); LESLIE D. BAYCH, CEDAR RAPIDS, IA (US); WALTER F. EMIG, CEDAR RAPIDS, IA (US)

(21) Appl. No.: 15/053,817

(22) Filed: Feb. 25, 2016

Related U.S. Application Data
(63) Continuation-in-part of application No. 14/108,938, filed on Dec. 17, 2013.
(60) Provisional application No. 62/205,108, filed on Aug. 14, 2015.
(60) Provisional application No. 61/854,616, filed on Apr. 29, 2013.

(51) Int. Cl. H05B 37/02; H04L 12/10

(52) U.S. Cl. CPC H05B 37/0245; H04L 12/10; H05B 37/0218

(57) ABSTRACT

The present invention relates to a system, method, and apparatus for powering intelligent lighting networks. The power for the intelligent lighting network is supplied by Power-over-Ethernet (PoE) switches and/or Mid-Spans, which are conditioned by a powered device to distribute power tuned specifically for each, at least one light emitting diode (LED) fixture. The Power-over-Ethernet switch and/or Mid-Span with associated router and wireless access point can be used to communicate with, and power a sensor network that collects data relevant to the intelligent lighting network. Optionally, the Power-over-Ethernet switch and/or Mid-Span can be used to communicate with, and power a network of sensors that collects data relevant to the space the intelligent lighting network is operating in, or can be used to communicate with and power a network of AC wall plugs that can be turned on and off, and various switches, relays, and PLCs, RFID systems, USB hubs, etc.

### CROSS-REFERENCE TO RELATED APPLICATIONS

This application is a Continuation-in-Part of U.S. Ser. No. 15/005,886, filed on Jan. 25, 2016, which claims priority under 35 U.S.C. §119 to Provisional Application U.S. Ser. Nos.: (i) 62/107,092 and 62/107,104, both filed on Jan. 23, 2015; (ii) 62/165,510, 62/165,485, 62/165,478, 62/165,468, 62/165,462, 62/165,449, 62/165,442, and 62/165,435, all filed on May 22, 2015; (iii) 62/173,419, 62/173,421, 62/173,424, 62/173,430, 62/173,438, 62/173,442, 62/173,444, 62/173,447, 62/173,482, 62/173,464, and 62/173,466, all filed on Jun. 10, 2015; and (iv) 62/205,067, 62/205,079, 62/205,082, 62/205,085, 62/205,091, 62/205,094, 62/205,108, and 62/205,110, all filed Aug. 14, 2015.

Further, this application is a Continuation-in-Part of U.S. Ser. No. 14/145,577, filed on Dec. 31, 2013, which claims priority under 35 U.S.C. §119 to Provisional Application U.S. Ser. Nos.: (i) 61/848,321, 61/848,322, 61/848,323 all filed on Dec. 31, 2012; (ii) 61/852,940 filed Mar. 25, 2013; and (iii) 61/854,633 61/854,632, 61/854,631, 61/854,630, 61/854,629, 61/854,628, 61/854,627, 61/854,625, 61/854,624, 61/854,623, 61/854,618, 61/854,617, 61/854,616, 61/854,615, 61/854,614, 61/854,613, 61/854,610, all filed on Apr. 29, 2013.

Still further, this application is a Continuation-in-Part of U.S. Ser. No. 14/145,577, filed on Dec. 31, 2013, which is a Continuation-in-Part of U.S. Ser. No. 14/108,938, filed Dec. 17, 2013, which claims priority under 35 U.S.C. §119 to Provisional Application U.S. Ser. Nos. 61/797,877, 61/797,873, 61/797,872, 61/797,870, 61/797,869, 61/797,86, 61/797,865, all filed on Dec. 17, 2012.

All of the above application are herein incorporated by reference in their entirety. The entire contents of these applications are hereby expressly incorporated herein by reference including, without limitation, the specification, claims, and abstract, as well as any figures, tables, or drawings thereof.

### FIELD OF THE DISCLOSURE

The present invention relates to a system, method, and apparatus for powering intelligent lighting networks. Power for the intelligent lighting network is supplied by Power-over-Ethernet (PoE) switches and/or Mid-Spans, which are conditioned by a powered device to distribute power tuned specifically for each, at least one light emitting diode (LED) fixture.

### BACKGROUND OF THE DISCLOSURE

Traditional LED lighting systems use drivers at each light fixture to convert AC power to suitable DC power. Drivers are typically mounted with the light fixtures, and located in the space above the ceiling. In this type system for LED lighting, the LED lighting fixtures are part of the existing AC electrical circuits. On-Off-Dim controls can be provided by wall switches and dimmers, timers, sensors, or lighting control software programs that are connected to an AC electrical branch circuit; or controllers located within the LED driver that use powerline, low voltage, or wireless communications to be connected to wall switches and dimmers, timers, sensors, or lighting control software programs.

Power-over-Ethernet LED lighting systems use PoE Switch power that is centrally located. The PoE Switch converts AC power to DC power. Intermediate electronics condition the power so it is suitable for use by LED lighting fixtures. The Intermediate electronics also include controllers that use structured cabling and/or wireless for communications.

What is needed is a Power-over-Ethernet LED Lighting system, method, and apparatus for powering intelligent lighting networks that is cost effective and energy efficient. The power for such an intelligent lighting network would be supplied by Power-over-Ethernet switches and/or Mid-Spans, which are conditioned by a powered device to distribute power tuned specifically for each, at least one LED fixture.

### SUMMARY OF THE DISCLOSURE

It is an object of the present invention to provide a system, method, and apparatus for continuously refreshing DC power between on and off states, or on and reduced voltage states, to LED lights.

It is a feature and object of the present invention to use direct current technology to provide functionality.

It is a feature and object of the present invention to use power inverter technology to provide functionality.

It is a feature and object of the present invention to use Time Domain Reflectometry (TDR) technology to provide functionality.

It is a feature and object of the present invention to use pulse width modulation duty cycle technology to provide functionality.

It is a feature and object of the present invention to use switch technology to provide functionality.

It is a feature and object of the present invention to use voltage regulator technology to provide functionality.

It is a feature and object of the present invention to use rectifier technology to provide functionality.

It is a feature and object of the present invention to use computer backplane technology to provide functionality.

It is a feature and object of the present invention to use common power bus technology to provide functionality.

It is a feature and object of the present invention to use Ethernet technology to provide functionality.

It is a feature and object of the present invention to use low voltage wiring technology to provide functionality.

It is a feature and object of the present invention to use twisted pair cable technology to provide functionality.

It is a feature and object of the present invention to use Category 5 cable technology to provide functionality.

It is a feature and object of the present invention to use Category 6 cable technology to provide functionality.

It is a feature and object of the present invention to use Category 7 cable technology to provide functionality.

It is a feature and object of the present invention to use modular connector technology to provide functionality.

It is a feature and object of the present invention to use blade server technology to provide functionality.

It is a feature and object of the present invention to use router technology to provide functionality.

It is a feature and object of the present invention to use Power-over-Ethernet technology to provide functionality.

It is a feature and object of the present invention to use powerline communication technology to provide functionality.

It is a feature and object of the present invention to use phantom power technology to provide functionality.

It is a feature and object of the present invention to use network switch technology to provide functionality.

It is a feature and object of the present invention to use relay technology to provide functionality.

It is a feature and object of the present invention to use ultra-wideband technology to provide functionality.

It is a feature and object of the present invention to use time division for power to provide functionality.

It is a feature and object of the present invention to use refresh rate to provide functionality.

It is a feature and object of the present invention to use flicker to provide functionality.

It is a feature and object of the present invention to use temporal resolution to provide functionality.

It is a feature and object of the present invention to use computer port technology to provide functionality.

It is a feature and object of the present invention to use modular electronics technology to provide functionality.

It is a feature and object of the present invention to use DMX technology to provide functionality.

It is a feature and object of the present invention to use ambient light sensor technology to provide functionality.

It is a feature and object of the present invention to use motion sensor technology to provide functionality.

It is a feature and object of the present invention to use ambient light sensor chronology to provide functionality.

Such an energy efficient system would use a dimmer matrix that is designed to provide the correct amount of electrical power for any specific dimmer setting for an LED fixture, or a daisy chain of LED fixtures. Such an energy efficient system would use two, or more physical channels to provide power to an LED fixture at a lower pulse width modulation (PWM) duty cycle setting, or to power a daisy chain of LED fixtures. Such a cost efficient system would take advantage of using lower PWM duty cycles on two physical channels for each LED fixture, or daisy chain of LED fixtures, to create time bins for N groups of LEDs, or daisy chains of LED fixtures, drawing power from the same Power-over-Ethernet port using a time division multiplexing scheme to reduce Power-over-Ethernet and/or Mid-Span port costs. In addition, a Power-over-Ethernet switch and/or Mid-Span with associated router and wireless access point would be used to communicate with and power, a sensor network that collects data relevant to the intelligent lighting network. Optionally, the Power-over-Ethernet switch and/or Mid-Span with associated router and wireless access point would be used to communicate with and power, a network of sensors that collects data relevant to the space the intelligent lighting network is operating in. Optionally, the Power-over-Ethernet switch and/or Mid-Span with associated router and wireless access point would be used to communicate with and power, a network of AC wall plugs that can be turned on and off, and various switches, relays, and PLCs, RFID systems, USB hubs, etc.

A non-linear dimmer matrix can be constructed to manage light output luminosity vs. power input so that each LED fixture, or daisy chained group of LED fixtures, is using the minimum amount of electricity to produce the required light at any dimmer setting.

A second benefit of operating using two stacked physical channels is a time division multiplexing scheme can be constructed that allows multiple LED fixtures, or multiple daisy chains of LED fixtures, to be powered by a single PoE port. As an example, using Chart 1 we can operate three (3) LED fixtures using a time division multiplexing scheme, in which each LED fixture is operating using two stacked physical channels, operating with a 33% duty cycle, and then staggering the start time of each LED fixture so that only one (1) LED fixture is drawing power at any point in time. In this example, three (3) LED fixtures, or daisy chains of LED fixtures, can operate on a single Power-over-Ethernet or Mid-Span port using a series of staggered start times, which greatly reduces Power-over-Ethernet Switch and/or Mid-Span equipment costs.

The primary features of the present invention are: 1) stacking at least two physical channels to drive each LED fixture, or daisy chain of LED fixtures, 2) managing dimmer settings using linear luminosity requirements vs. uncorrelated linear power settings, and 3) managing the start time for each LED fixture, or daisy chain of LED fixtures, and the present invention also uses 4) sensors to detect ambient light conditions related to a particular LED fixture, or zone of LED fixtures, identified by room or space definitions that are cross-referenced to OSHA requirements, National and Local building code requirements, standards organizations, and/or customer requirements to either minimum or desired ambient light conditions. As an example, the requirements for a building corridor are much different than for a hospital room, office space or lobby. The present invention's dimmer controls can be set to operate according to static dimmer settings in the lighting program that are adjusted according to signals received from at least one strategically place ambient light sensor, or by automatically adjusted dimmer settings according to signals received from at least one strategically placed ambient light sensor which are cross-referenced to tables for spaces and rooms defined in OSHA regulations, and/or National and Local building codes, standards organizations, or proprietary requirements. The fifth (5th) primary feature of the present invention is intelligent lighting systems can be self-configuring using AutoID technologies, such as, but not limited to, RFID tags, barcoded tags, etc., to simplify the installation, commissioning, and warranty processes for simple, or very complicated, lighting environments.

These features of the present invention will be described in more detail in the detailed description of the various embodiments of the present invention.

### BRIEF DESCRIPTION OF THE FIGURES

FIG. 1 is an illustration of the present invention shown in context of its larger eco-system.

FIG. 2 is an illustration of an alternate embodiment of the present invention shown in context of its larger eco-system.

FIG. 3 is an illustrative embodiment of the present invention.

FIG. 4 is an illustration of an exemplary transponder configured for use within the present invention.

### DETAILED DESCRIPTION OF THE DISCLOSURE

The present invention relates to a system, method, and apparatus for powering intelligent lighting networks, and includes an integrated data collection and marketing system. The power for the intelligent lighting network is supplied by Power-over-Ethernet switches, which is conditioned to properly power LED fixtures. In addition, the Power-over-Ethernet switch, associated router, and wireless access point, can be used to power a sensor network that collects data that is relevant to a client and their customers. Furthermore, the data collected from the sensor network can be used to drive a marketing system that also is connected to the Power-over-Ethernet switch, associated router, and wireless access point.

LEDs are following Moore's Law, and growing in efficacy at a good rate. The following is a chart for a 2′×2′ LED fixture that is engineered with 100 lumens per watt (LPW) diodes. Chart 1 records pulse width modulation (PWM) settings vs. measured foot-candles per Watt (fc/Watt). The results illustrate the non-linear response of LEDs light output vs input energy, and the energy saved at various dimmer settings vs a traditional linear power setting for a 0-10V dimmer. The Non-Linear Dimmer Matrix Setting for 100% light is selected to be 900 fc, which allows a 5.56% overhead as the LED fixture begins to degrade over time.

CHART 1
Single Physical Channel for Powering a LED Fixture

| | | | | | | Energy Saved |
|---|---|---|---|---|---|---|
| | | | | | Corresponding | Vs. |
| | | | | % Light Using 900 | Non-Linear | Traditional |
| | | | | fc As The Top End | Dimmer Matrix | Linear Power |
| PWM Duty Cycle | fc | Watts | fc/Watt | Design Setting | Setting | Setting |
| 100 | 950 | 30.13 | 31.53 | 105.56% | | |
| 99 | 950 | 29.85 | 31.83 | 105.56% | | |
| 98 | 900 | 29.66 | 30.34 | 100.00% | | |
| 97 | 900 | 29.66 | 30.34 | 100.00% | | |
| 96 | 900 | 29.42 | 30.60 | 100.00% | | |
| 95 | 900 | 29.25 | 30.77 | 100.00% | | |
| 94 | 900 | 29.10 | 30.93 | 100.00% | | |
| 93 | 900 | 29.07 | 30.96 | 100.00% | | |
| 92 | 900 | 28.88 | 31.16 | 100.00% | | |
| 91 | 900 | 28.69 | 31.37 | 100.00% | | |
| 90 | 900 | 28.53 | 31.55 | 100.00% | | |
| 89 | 900 | 28.37 | 31.72 | 100.00% | | |
| 88 | 900 | 28.20 | 31.92 | 100.00% | | |
| 87 | 900 | 28.02 | 32.12 | 100.00% | | |
| 86 | 900 | 27.82 | 32.35 | 100.00% | | |
| 85 | 900 | 27.69 | 32.50 | 100.00% | | |
| 84 | 900 | 27.49 | 32.74 | 100.00% | | |
| 83 | 900 | 27.29 | 32.98 | 100.00% | | |
| 82 | 900 | 27.07 | 33.25 | 100.00% | | |
| 81 | 900 | 26.90 | 33.46 | 100.00% | | |
| 80 | 900 | 26.63 | 33.80 | 100.00% | | |
| 79 | 900 | 26.41 | 34.08 | 100.00% | | |
| 78 | 900 | 26.14 | 34.43 | 100.00% | | |
| 77 | 900 | 25.90 | 34.75 | 100.00% | 100% | 14.04% |
| 76 | 830 | 25.60 | 32.42 | 92.22% | | |
| 75 | 830 | 25.33 | 32.77 | 92.22% | | |
| 74 | 830 | 25.04 | 33.15 | 92.22% | | |
| 73 | 830 | 24.71 | 33.59 | 92.22% | | |
| 72 | 830 | 24.37 | 34.05 | 92.22% | | |
| 71 | 830 | 24.05 | 34.51 | 92.22% | | |
| 70 | 830 | 23.67 | 35.06 | 92.22% | | |
| 69 | 830 | 23.30 | 35.62 | 92.22% | | |
| 68 | 830 | 22.92 | 36.21 | 92.22% | | |
| 67 | 830 | 22.50 | 36.90 | 92.22% | | |
| 66 | 830 | 22.06 | 37.62 | 92.22% | | |
| 65 | 830 | 21.64 | 38.35 | 92.22% | | |
| 64 | 830 | 21.22 | 39.11 | 92.22% | | |
| 63 | 830 | 20.81 | 39.89 | 92.22% | | |
| 62 | 830 | 20.34 | 40.81 | 92.22% | | |
| 61 | 830 | 19.83 | 41.85 | 92.22% | | |
| 60 | 830 | 19.18 | 43.27 | 92.22% | | |
| 59 | 830 | 18.42 | 45.05 | 92.22% | | |
| 58 | 800 | 17.88 | 44.74 | 92.22% | | |
| 57 | 800 | 17.25 | 46.39 | 88.89% | | |
| 56 | 800 | 16.74 | 47.79 | 88.89% | | |
| 55 | 800 | 16.09 | 49.73 | 88.89% | 90% | 40.68% |
| 54 | 700 | 15.52 | 45.09 | 77.78% | | |
| 53 | 700 | 14.97 | 46.77 | 77.78% | | |
| 52 | 700 | 14.44 | 48.49 | 77.78% | 80% | 40.11% |
| 51 | 670 | 13.97 | 47.96 | 74.44% | | |
| 50 | 670 | 13.49 | 49.67 | 74.44% | | |
| 49 | 670 | 12.98 | 51.63 | 74.44% | | |
| 48 | 640 | 12.49 | 51.24 | 71.11% | | |
| 47 | 640 | 11.99 | 53.36 | 71.11% | | |
| 46 | 640 | 11.56 | 55.37 | 71.11% | 70% | 45.20% |
| 45 | 600 | 11.08 | 54.14 | 66.66% | | |
| 44 | 600 | 10.65 | 56.34 | 66.66% | | |
| 43 | 600 | 10.21 | 58.78 | 66.66% | | |
| 42 | 600 | 9.77 | 61.41 | 66.66% | | |
| 41 | 550 | 9.34 | 58.86 | 61.11% | | |
| 40 | 550 | 8.88 | 61.91 | 61.11% | | |
| 39 | 550 | 8.50 | 64.67 | 61.11% | 60% | 48.31% |
| 38 | 500 | 8.15 | 61.32 | 55.55% | | |
| 37 | 500 | 7.75 | 64.53 | 55.55% | | |
| 36 | 480 | 7.37 | 65.13 | 53.33% | | |
| 35 | 480 | 7.14 | 67.26 | 53.33% | | |
| 34 | 440 | 6.81 | 64.61 | 48.89% | | |
| 33 | 440 | 6.42 | 68.58 | 48.89% | | |
| 32 | 440 | 6.12 | 71.90 | 48.89% | 50% | 54.80% |
| 31 | 410 | 5.85 | 70.08 | 45.55% | | |
| 30 | 410 | 5.48 | 74.87 | 45.55% | | |
| 29 | 400 | 5.18 | 77.20 | 44.44% | | |
| 28 | 400 | 4.93 | 81.20 | 44.44% | | |
| 27 | 360 | 4.70 | 76.61 | 40.00% | | |
| 26 | 360 | 4.46 | 80.66 | 40.00% | 40% | 62.97% |
| 25 | 340 | 4.13 | 82.36 | 37.78% | | |
| 24 | 340 | 3.89 | 87.44 | 37.78% | | |
| 23 | 320 | 3.69 | 86.61 | 35.55% | | |
| 22 | 300 | 3.51 | 85.51 | 33.33% | | |
| 21 | 300 | 3.25 | 92.26 | 33.33% | | |
| 20 | 270 | 3.06 | 88.35 | 30.00% | 30% | 66.19% |
| 19 | 240 | 2.99 | 80.36 | 26.67% | | |
| 18 | 240 | 2.78 | 86.36 | 26.67% | | |
| 17 | 220 | 2.59 | 85.05 | 24.44% | | |
| 16 | 200 | 2.33 | 85.75 | 22.22% | | |
| 15 | 200 | 2.15 | 92.99 | 22.22% | | |
| 14 | 190 | 1.98 | 95.78 | 21.11% | | |
| 13 | 180 | 1.72 | 104.48 | 20.00% | 20% | 71.41% |
| 12 | 170 | 1.57 | 108.27 | 18.89% | | |
| 11 | 150 | 1.36 | 109.99 | 16.67% | | |
| 10 | 130 | 1.20 | 108.46 | 14.44% | | |
| 9 | 120 | 1.09 | 110.00 | 13.33% | | |
| 8 | 100 | 0.86 | 115.83 | 11.11% | | |
| 7 | 90 | 0.73 | 123.88 | 10.00% | 10% | 75.89% |
| 6 | 73 | 0.64 | 113.99 | 8.11% | | |
| 5 | 64 | 0.51 | 125.66 | 7.11% | | |
| 4 | 50 | 0.44 | 112.54 | 5.56% | | |
| 3 | 37 | 0.35 | 105.14 | 4.11% | | |
| 2 | 25 | 0.26 | 96.41 | 2.78% | | |
| 1 | 12 | 0.11 | 106.67 | 1.33% | | |

Chart 1 illustrates:

At a PWM duty cycle of 77%, the output of the LED fixture is 900 fc, which saves 14.04% energy vs. running the LED fixture at a PWM duty cycle of 100%.

At a PWM duty cycle of 52%, the output of the LED fixture is 700 fc (or a non-linear dimmer matrix setting of 80%), which saves 40.11% energy vs. running the LED fixture at a PWM duty cycle of 100%.

At a PWM duty cycle of 46%, the output of the LED fixture is 640 fc (or a non-linear dimmer matrix setting of 70%), which saves 45.20% energy vs. running the LED fixture at a PWM duty cycle of 100%.

At a PWM duty cycle of 32%, the output of the LED fixture is 440 fc (or a non-linear dimmer matrix setting of 50%), which saves 54.80% energy vs. running the LED fixture at a PWM duty cycle of 100%.

Therefore as an example, using two stacked physical channels, both operating at a PWM duty cycle of 0.333, the present invention can make approximately 100% of the maximum light (900 fc) while saving approximately six (6) to eight (8) watts vs. running the same LED fixture at a PWM duty cycle of 100%, which is a primary benefit of the present invention.

In addition, the Power-over-Ethernet switch, associated router, and wireless access point, can be used to power a sensor network that collects data that is relevant to a client and their customers.

Furthermore, the data collected from the sensor network can be used to drive a marketing system that also is connected to the Power-over-Ethernet switch, associated router, and wireless access point.

Even furthermore, the present invention includes a power distribution unit, referred to throughout the description of the present invention as Power Station 130, which includes an integrated Lighting System Controller and optional integrated Industrial System Controller, a structured cabling network, sensors, wall switches, and LED fixtures.

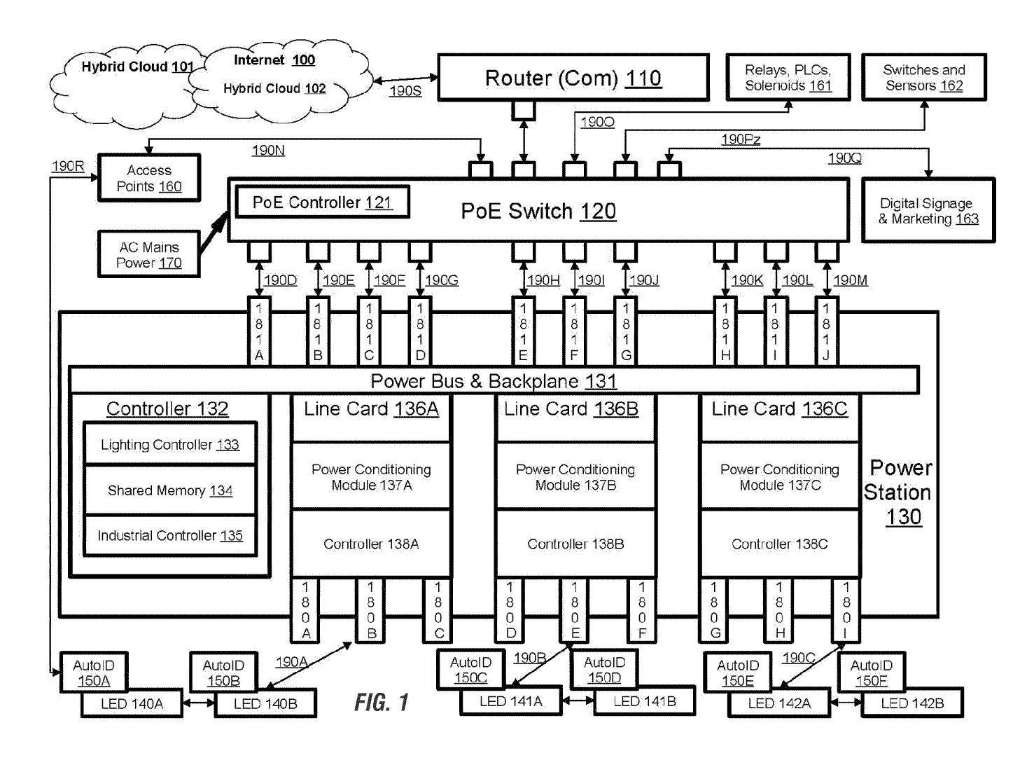

FIG. 1 is an illustration of one embodiment of the present invention in which the Power Station 130 includes Controller 132, Lighting Controller 133, Shared Memory 134, Optional Industrial Controller 135, and Line Cards 136A, B, C integrated in a rack-mountable chassis, which includes the elements, objects, features, and benefits described as follows.

Internet 100 is a global system of interconnected computer networks that use the Internet protocol suite (TCP/IP) to link several billion devices worldwide. It is a network of networks that consists of millions of private, public, academic, business, and government networks of local to global scope, linked by a broad array of electronic, wireless, and optical networking technologies. The Internet carries an extensive range of information resources and services, such as the inter-linked hypertext documents and applications of the World Wide Web (WWW), the infrastructure to support email, telephony, and peer-to-peer networks for file sharing. Internet 100 also illustrates the deployment of Hybrid Cloud 102. Hybrid Clouds are further described in element 101 following. The Hybrid Cloud 102 that operates on Internet 100 includes applications, software, and databases for an enterprise resource planning (ERP) system, and an ISO/OSHA graphical user interface (GUI) that is a series of interconnected processes that overlay the present invention's ERP system. In addition, Hybrid Cloud 102 includes applications, software, and databases for Lighting as a Service (LaaS) system, Marketing as a Service (MaaS) system, VoIP as a Service (VoIPaaS) system, and Location as a Service (XYZaaS) system. Hybrid Cloud 102 is built using Cisco Integration Platform (CIP) and Cisco Intercloud products. Both of these products are further described in Hybrid Cloud 101.

Hybrid Cloud 101 is a composite cloud service that crosses the boundaries of private, public, and community clouds that extends the capacity and capability, via aggregation and integration, of the composite cloud service provided by the present invention. As an example, the present invention may store sensitive client data in house on a private cloud application and interconnect that application to a business intelligence application provided on a public cloud, as a software service. In the present invention, Hybrid Cloud 101 and Hybrid Cloud 102 communicate over Internet 100. The data is collected and stored as a result of using the present invention's sensors that are part of LaaS (Lighting as a Service) and MaaS (Marketing as a Service) systems. These sensors include WiFi and Bluetooth MAC addresses, temperature readings, camera gathered data, lighting system sensors that detect occupancy, vacancy, and ambient lighting conditions, etc. The hybrid cloud structure represented as Hybrid Cloud 101 and Hybrid Cloud 102 may use public cloud computing resources to meet temporary capacity needs that cannot be met by our private cloud. This capability enables the present invention's hybrid cloud to employ cloud bursting for scaling across at least one cloud, or a multiplicity of clouds. The primary application running in the Hybrid Cloud 101 is the present invention's Data as a Service (DaaS) engine, which includes data storage and data analytic services. Hybrid Cloud 101 also includes a Coupon Exchange for uniquely identified offers and discounts, and analytic engines, such as, but to limited to GAUSS, and GUIs for the MaaS system to request data to offer uniquely identified discounts, coupons, etc. to the MaaS system's customer's client's that have opted into the system. These uniquely identified discounts, coupons, etc. are offered to a MaaS client's customer's on-the-fly, based on analytics of past and present customer behaviors.

Hybrid Cloud 101 and Hybrid Cloud 102 may be constructed using Cisco's Intercloud product. In addition, Hybrid Cloud 101 and Hybrid Cloud 102 may be constructed using Cisco's Integration Platform, aka CIP. CIP is used to connect the present inventions diverse, on premise cloud, and DaaS applications across the business enterprise, and makes it easy to exchange data and services between them. This is done in an automated fashion, reusing application integrations and APIs to accelerate the delivery of new customer experiences, at a much lower cost.

The CIP solution brings together two powerful technologies:

1) Cisco Integration Bus, an open standards-based integration platform with over 120 prebuilt application connectors, graphical design tools, and mixed-model deployment tools, in order to integrate and deploy applications or services seamlessly and quickly.

2) API Management, a comprehensive suite of life-cycle management capabilities to design, build, and manage APIs for our systems and services.

The combination of these technologies provides the present invention a full set of enterprise-class tools and capabilities to create, deploy, manage, and capitalize on application integrations and APIs throughout our business. These include:
1) High reliability, with clustering for high availability and enterprise scalability
2) Broad business visibility through a Business Event Analyzer
3) Fast problem resolution with the Service Flow Analyzer
4) Strong security with role-based access control and Security Assertion Markup Language (SAML)
5) Accelerated deployments with the Deployment Manager and Integrated Repository
6) Advanced performance management with service-level agreement (SLA) alerts, Monitoring Framework Integration, and a Run-time Performance Manager
7) Simplified and pervasive operational control with tools like Integration Bus Remote Control, Task Scheduler, Operational Dashboard, and a Representational State Transfer (REST) API for Management

Router 110 is a networking device that forwards data packets between computer networks. Routers perform the “traffic directing” functions on the Internet. A data packet is typically forwarded from one router to another through the networks that constitute the internet, until it reaches its destination node.

A router is connected to two or more data lines from different networks (as opposed to a network switch, which connects data lines from one single network). When a data packet comes in on one of the lines, the router reads the address information in the packet to determine its ultimate destination. Then, using information in its routing table or routing policy, it directs the packet to the next network on its journey. This creates an overlay inter-network. Router 110 is also a security appliance.

Network Connection 190S represents the connection from the premise where the LaaS network rack is located and Internet 100. This connection can include a variety of, but is not limited to, wired, and/or wireless, and/or fiber-optic connections, as well as an ISP modem, and head-end equipment, POTS networks, cable networks, satellite networks, microwave relays, LANS, WANS, cellular networks including a hot spot, etc.

PoE Switch 120 describes any of several standardized or ad-hoc systems which pass electrical power along with data on Ethernet cabling. This allows a single cable to provide both data connection and electrical power to devices such as wireless access points, IP cameras, and LED lights. Unlike standards such as Universal Serial Bus which also power devices over the data cables, PoE allows long cable lengths. Power may be carried on the same conductors as the data, or it may be carried on dedicated conductors in the same cable.

PoE Switch 120 also includes PoE Controller 121.

There are several common techniques for transmitting power over Ethernet cabling. Two of them have been standardized by IEEE 802.3. Since only two of the four pairs are needed for 10BASE-T or 100BASE-TX, power may be transmitted on the unused conductors of the cable. In the IEEE standards, this is referred to as Alternative B. Power may also be transmitted on the data conductors by applying a common-mode voltage to each pair. Because twisted-pair Ethernet uses differential signaling, this does not interfere with data transmission. The common mode voltage is easily extracted using the center tap of the standard Ethernet pulse transformer. This is similar to the phantom power technique commonly used for powering audio microphones. In the IEEE standards, this is referred to as Alternative A.

In addition to standardizing existing practice for spare-pair and common-mode data pair power transmission, the IEEE PoE standards provide for signaling between the power sourcing equipment (PSE) and powered device (PD). This signaling allows the presence of a conformant device to be detected by the power source, and allows the device and source to negotiate the amount of power required or available. Up to a theoretical 51 watts is available for a device, depending on the version of the standard in use and the vendor of the hardware.

A switch is a device in a computer network that electrically and logically connects together other devices. Multiple data cables are plugged into a switch to enable communication between different networked devices. Switches manage the flow of data across a network by transmitting a received message only to the one or more devices for which the message was intended. Each networked device connected to a switch can be identified using a MAC address, allowing the switch to regulate the flow of traffic. This maximizes security and efficiency of the network.

Due to these features, a switch may be seen as more “intelligent” than a network hub, which provides no security or identification of connected devices. As a result, messages have to be transmitted out of every port of the hub, greatly degrading the overall efficiency of the network.

An Ethernet switch operates at the data link layer (layer 2) of the OSI model to create a separate collision domain for each switch port. Each computer connected to a switch port can transfer data to any of the other ones at a time, and the transmissions may not interfere, with the limitation that, in half duplex mode, each line can only either receive from or transmit to its connected computer at a certain time. In full duplex mode, each line can simultaneously transmit and receive, regardless of the partner.

PoE Switch 120 transmits both data and power to the present invention's Power Station 130. The present invention's Power Station 130 is a power management and distribution switch architected to enable the next phase of the PoE-powered LED lighting evolution. The Power Station 130 is also a combiner that aggregates power from several PoE ports into several common power buses operating on Power Station 130. The Power Station 130 provides a solution to intelligently manage and distribute power provided by PoE sources, including switches and Mid-Spans, to high efficiency LED lights, while maximizing operational cost savings. The Power Station 130 is future-enabled with vertical and horizontal power regulation and distribution across multiple channels operating on multiple ports to optimize port usage for the LED industries efficiency gains, and to allow for LED lights with different power requirements to operate on the same Power Station 130. The present invention's digital intelligent Lighting System Controller is fully integrated in the Power Station 130. Optionally, the Lighting System Controller is designed to include an industrial bus controller for managing and operating relays, solenoids, PLCs, and for communicating with building automation systems, etc. In addition, the Power Station 130's back-end systems are designed to take advantage of the Cisco Integration Platform, and the Cisco Intercloud product offering. Overall, the present invention's Power Station 130 offers unparalleled cost savings for PoE-powered LED lighting networks. The Power Station 130 uses the PoE Switch 120 to power and communicate with a sensor network, other Power Station 130s, and back-end systems. The present invention's PoE switch powered solution is robust, agile, and takes advantage of the inherent features and benefits of PoE switches, such as, but not limited to, security and unified communications.

The present invention's Power Station 130 is a modular platform that may be re-configured internally to provide a variety of port configurations, such as, but not limited to: an 8 port power station, a 12 port power station, a 16 port power station, a 20 port power station, a 24 port power station, a 28 port power station, a 32 port power station, a 36 port power station, a 40 port power station, a 44 port power station, a 48 port power station, a 60 port power station, a 72 port power station, a 96 port power station, a 144 port power station, a 192 port power station, etc.

The Power Station 130s are designed for scalability. The modular architecture of these platforms enables the deployment of small, medium, and large PoE-powered LED lighting networks.

The key features and benefits of the present invention's Power Station 130 are illustrated in Chart 2 which includes, but is not limited to:

CHART 2

| Features | Benefits | |
|---|---|---|
| PoE Power | 1) | The present invention's Power Stations 130 are powered |
| or | | by off-the-shelf PoE switches or Mid-Spans that are very |
| Mid-Span Power | | reliable. Depending on the model, they can provide |
| | | 150,000 to 400,000 hours MTBF. |
| | 2) | The off-the-shelf PoE switches or Mid-Spans used to |
| | | power the present invention's Power Stations 130 can be |
| | | configured with dual, hot-swappable power supplies. |
| | 3) | The off-the-shelf PoE Switches used to power the present |
| | | invention's Power Stations 130 may be configured to |
| | | share power vertically between as many as four inter- |
| | | connected, stacked switches. |
| | 4) | The Power Station 130 is designed to negotiate individual |
| | | port power requirements with off-the-shelf PoE switches. |
| Tunable Power | 1) | The present invention's Power Stations 130 can be |
| | | programmed to condition the PoE supplied power to the |
| | | appropriate voltage and amperage requirements for any |
| | | manufacturer's LED fixtures without requiring a DC |
| | | power-supply, or driver. The primary benefit is flexibility |
| | | for the end-user to choose LED fixtures that meet their |
| | | architectural requirements without limitation. |
| | 2) | The present invention's Power Stations 130 tunable power |
| | | can be programmed to be implemented within sub-groups |
| | | of channels on the same Power Station, so that LED |
| | | fixtures with differing power requirements can all be |
| | | supplied simultaneously. |
| Stacked PWM Channels | 1) | The present invention's Power Stations 130 are powered |
| | | by Stacked PWM channels operating on the same output |
| | | port. Stacking PWM channels allows the Power Station |
| | | 130 to take advantage of the non-linear response of LEDs |
| | | to input power, in order to provide full lumen output at |
| | | approximately 33% of the duty cycle of a full PWM |
| | | regularly repeating cycle. The primary benefit is less |
| | | energy is required to provide full lumens using Stacked |
| | | PWM channels. The second benefit is more lights can |
| | | operate on the same output port. The tertiary benefit is less |
| | | energy means less heat, which means even longer life for |
| | | LEDs. |
| Time Division Multiplexing | 1) | The present invention's Power Stations 130 Stacked PWM |
| | | channel feature on a single output port can be used with a |
| | | Time Division Multiplexing scheme to sequence PWM |
| | | duty cycle start times to be off-set, so as many as three |
| | | adjacent ports can be powered using a power supply that |
| | | is 1/3 the size required if all three adjacent ports were |
| | | operating on random, uncontrolled PWM cycle start |
| | | times. Although, the same amount of power is needed to |
| | | power a series of LED fixtures, the goal isn't to specify a |
| | | power supply that is 1/3 the size required. The goal, and |
| | | primary benefit of Time Division Multiplexing, is the |
| | | ability to power up to 3X additional LED fixtures per PoE |
| | | Switch and Power Station combination. |
| Common Power Bus | 1) | The present invention's Power Stations 130 are configured |
| and | | such that three, or perhaps four, adjacent ports operate on |
| Back-plane | | a Common Power Bus. The primary benefit is powered |
| | | devices requiring more than 60 watts of power can be |
| | | supplied. In addition, the bus provides a standard |
| | | connection for four port line cards. The line cards include |
| | | a micro-controller, a variable power supply, DMX for |
| | | controlling power sequencing and combining power, |
| | | PWM engines for On/Off-Dimming, and are designed to |
| | | plug into a common backplane. |
| Rack-Mounted | 1) | The present invention's Power Station 130 is 1U high, |
| | | rack mountable network gear designed to be familiar to |
| | | technicians, and installation crews. In addition, the rack- |
| | | mountable Power Station 130 may be in close proximity |
| | | to the PoE switch or Mid-Span, which means neater, more |
| | | compact cabling. |
| Integrated Lighting | 1) | The present invention's Power Station 130 include two |
| Controller | | integrated controllers, a shared memory resource and |
| and | | logic engine, and an API, a DMX Lighting System |
| Optional Industrial | | Controller for the lighting system, and an OPC Industrial |
| Controller | | Bus controller for controlling relays, solenoids, PLCs, and |
| | | building automation systems operating on industrial |
| | | buses. The Lighting System Controller is designed to |
| | | plug into a common backplane. |
| | 2) | The present invention's Power Station 130 DMX Lighting |
| | | System Controller's logic engine provides for events, |
| | | event related trigger thresholds, and a programmable |
| | | Dimmer Matrix for PWM vs desired light levels. The |
| | | event definitions for a building lighting system can be |
| | | programmed via a GUI to include time-of-day, day-of- |
| | | week, holidays, opening time, closing time, personnel ID, |
| | | personnel location, local building code lighting level |
| | | requirements, national building code lighting level |
| | | requirements, building operator lighting level |
| | | requirements that exceed and supersede local and national |
| | | lighting level requirements, occupancy, vacancy, ambient |
| | | light level, imaging analysis, peak demands, etc. The |
| | | DMX Lighting System Controller can also be |
| | | programmed via GUI to respond to events and triggers for |
| | | non-building lighting systems, such as those related to |
| | | indoor agriculture. These events can include soil |
| | | conditions, temperature, humidity, air exchanges, nutrient |
| | | conditions, leaf wetness, IR imaging for plant |
| | | temperature, imaging for leaf color and plant health, |
| | | personnel ID, personnel location, equipment location, |
| | | time-of-day, day-of-week, holidays, opening time, closing |
| | | time, etc. The Lighting System Controller's lighting and |
| | | industrial controllers are both designed to respond to |
| | | events, and related triggers maintained in the logic engine. |
| | 3) | The present invention's Power Station 130 DMX Lighting |
| | | System Controller provides centralized control for one |
| | | master Power Station 130 and up to four slaved Power |
| | | Stations 130 in a conventional DMX universe. DMX is |
| | | well known in the lighting industry, and is a robust design |
| | | with 40 years of success in the marketplace. |
| | 4) | The second generation present invention's Power Station |
| | | 130 DMX Lighting System Controller may deliver DMX |
| | | over Ethernet to remove the constraint of one master |
| | | Power Station 130 and up to four slaved Power Stations |
| | | 130 in a conventional DMX universe. |
| | 5) | The present invention's Power Station 130 DMX Lighting |
| | | System Controller includes tables for defining building, |
| | | space, and room types according to national, regional, and |
| | | local standards. These tables are used to configure the |
| | | system, such that lights or groups of lights can be |
| | | automatically adjusted using sensors to adjust lumen |
| | | output levels to the correct and most efficient levels. |
| | | Using building, space, and room definitions is critical in |
| | | building intelligent lighting systems that self-configure, |
| | | and operate accordingly. |
| | 6) | The present invention's Power Station 130 DMX Lighting |
| | | System Controller includes the V-Pulse ® Non-Linear |
| | | Dimmer Matrix. This feature results in a dimmer that is |
| | | controlled by the desired light output setting that has been |
| | | mapped to the appropriate PWM duty cycle setting. The |
| | | primary benefit of this feature is extreme energy savings. |
| | | The secondary benefit is reduced operating temperatures, |
| | | which equates to longer life for LED fixtures. The third |
| | | benefit is a further reduction in air conditioning operating |
| | | costs needed to subtract the heat load caused by the |
| | | operation of a conventional lighting system. The fourth |
| | | benefit is longer operating ranges from the Power Station |
| | | 130. |
| | 7) | The present invention's Power Station 130 DMX Lighting |
| | | System Controller interfaces with sensors, switches, and |
| | | dimmers connected thru the PoE Switch 120 to create an |
| | | ad hoc control network to intelligently drive the LED |
| | | lighting system using occupancy, vacancy, ambient light |
| | | levels, motion, time of day, and date. In addition, sensors |
| | | such as temperature, humidity, O2, CO2, can be used to |
| | | intelligently drive the LED lighting system when used in |
| | | environments such as indoor farming applications. |
| | 8) | The present invention's Power Station 130 DMX Lighting |
| | | System Controller provides a scheduler that can be |
| | | programmed by a client via a web-based GUI. |
| | 9) | The present invention's Power Station 130 DMX Lighting |
| | | System Controller can interact wireless thru the PoE |
| | | Switch with an Installation Tool app, a Maintenance Tool |
| | | app, and a User Tool app. |
| | 10) | The present invention's Power Station 130 DMX Lighting |
| | | System Controller can also be connected to other Power |
| | | Station 130 DMX Lighting System Controllers, and can |
| | | be grouped together to operate in unison in the same |
| | | general region of a facility, disparate regions of the same |
| | | facility, multiple buildings on a campus, an entire campus, |
| | | or in a wide-area network of buildings that are widely |
| | | dispersed regionally, nationally, or inter-nationally. |
| | 11) | The present invention's Power Station 130 OPC Industrial |
| | | Bus controller provides the ability to control relays, |
| | | solenoids, and PLCs operating on industrial buses. The |
| | | present invention's Power Station 130 OPC Industrial Bus |
| | | controller can be connected to other Power Station 130 |
| | | OPC Industrial Bus controllers and can be grouped |
| | | together to operate in unison in the same general region of |
| | | a facility, disparate regions of the same facility, multiple |
| | | buildings on a campus, an entire campus, or in a wide-area |
| | | network of buildings that are widely dispersed regionally, |
| | | nationally, or inter-nationally. |
| | 12) | The present invention's Power Station 130 DMX Lighting |
| | | System Controller and OPC Industrial Bus controller |
| | | databases are designed to be easily inter-connected using |
| | | the Cisco Integration Platform. The DMX Lighting |
| | | System Controller and OPC Industrial Bus controller |
| | | databases are designed to record and seamlessly share |
| | | small data with a big Data as a Service database and |
| | | analytic engine. |
| Meraki MDM | 1) | The optional Meraki MDM software application provides |
| (Mobile Data Manager) | | unified management of Power Station 130 controllers, and |
| (Optional) | | the entire network of controllers, from a centralized |
| | | dashboard. MDM is used to intelligently and easily |
| | | enforce device security policies, deploy and upgrade O/S |
| | | and software, and perform remote, live troubleshooting on |
| | | thousands of network connected Power Station 130 |
| | | controllers. |

Power Station 130 may use input from the ambient light sensors in conjunction with the “building, space, room type” definition table and corresponding minimum light levels matrix that is stored in its memory, to select the correct light setting. The non-linear dimmer matrix that is stored in the Power Station 130's DMX Lighting System Controller memory may serve as a guide to constantly make the correct adjustments to the LED fixtures. The net result is the most efficient, and robust lighting system possible, one that is powered by PoE switches, and managed by the Power Station 130 with integrated Lighting Controller 133.

The present invention Power Station 130 provides a power management and distribution solution that is future-proofed. The efficacy of LEDs follows Moore's law, so PoE, PoE+, and UPoE power will nearly always be out of sync when optimizing available power to create logical lighting circuits. The Power Station 130 is a modular component in a PoE Switch 120—Power Station 130 combination, by conditioning standard PoE power to meet complex installation environments, and to meet the ever-changing landscape of increasing LED efficiencies.

Power Station 130 is comprised of the following: Power Bus and Back-plane 131, Controller 132, Lighting Controller 133, Shared Memory 134, optional Industrial Controller 135, Line Cards 136A, B, C, Power Conditioning Modules 137A, B, C, Micro-Controllers 138A, B, C, Input Power and Data Ports 181A, B, C, D, E, F, G, H, I, J and Output Power Ports 180A, B, C, D, E, F, G, H, I. Input power is provided by AC Mains Power 170. The Power Station 130 converts AC to DC for use by the PoE Switch, and in turn, the Power Station 130, and LED 140A, B (Mfg. A), LED 141A, B (Mfg. B), LED 142A, B (Mfg. C).

Power Bus and Back-plane 131 may be configured as a Distributed Power Architecture, or an Intermediate Bus Architecture.

Controller 132 may be a field-programmable gate array integrated circuit designed to be configured by a customer or a designer after manufacturing. The FPGA configuration is generally specified using a hardware description language (HDL), similar to that used for an application-specific integrated circuit (ASIC). Alternatively, Controller 132 may be configured as at least one micro-controller. A microcontroller, often abbreviated uC or MCU, is a small computer on a single integrated circuit containing a processor core, memory, and programmable input/output peripherals. Program memory in the form of Ferroelectric RAM, NOR flash or OTP ROM is also often included on chip, as well as a typically small amount of RAM. Microcontrollers are designed for embedded applications, in contrast to the microprocessors used in personal computers or other general purpose applications. Microcontrollers make it economical to digitally control even more devices and processes. Mixed signal microcontrollers are common, integrating analog components needed to control non-digital electronic systems. Some microcontrollers may use four-bit words and operate at clock rate frequencies as low as 4 kHz, for low power consumption (single-digit milliwatts or microwatts). They will generally have the ability to retain functionality while waiting for an event such as a button press or other interrupt; power consumption while sleeping (CPU clock and most peripherals off) may be just nanowatts, making many of them well suited for long lasting battery applications. Other microcontrollers may serve performance-critical roles, where they may need to act more like a digital signal processor (DSP), with higher clock speeds and power consumption.

Typically, FPGAs contain an array of programmable logic blocks, and a hierarchy of reconfigurable interconnects that allow the blocks to be “wired together”, like many logic gates that can be inter-wired in different configurations. Logic blocks can be configured to perform complex combinational functions, or merely simple logic gates like AND and OR. In most FPGAs, logic blocks also include memory elements, which may be simple flip-flops or more complete blocks of memory.

Controller 132 includes, but is not limited to, blocks designed for use as the Lighting Controller 133's Shared Memory 134, and an optional Industrial Controller 135.

In the preferred embodiment, Lighting Controller 133 is based on the DMX512A protocol. However, Lighting Controller 133 can be designed as a control system device, or set of devices, to manage, command, direct or regulate the behavior of other the LaaS system. The Lighting Controller 133 can be an open loop control system and/or a closed loop control systems. In open loop control systems output is generated based on inputs. In closed loop control systems current output is taken into consideration and corrections are made based on feedback. A closed loop system is also called a feedback control system. A hybrid control system may use both an open and closed loop control system.

DMX is a standard for digital communication networks that are commonly used to control stage lighting and effects. It was originally intended as a standardized method for controlling light dimmers, which prior to DMX512, had employed various incompatible proprietary protocols. It soon became the primary method for linking controllers such as a lighting console, to dimmers and special effects devices such as fog machines and intelligent lights. DMX has also expanded to uses in non-theatrical interior and architectural lighting, ranging from strings of Christmas lights to electronic billboards. DMX can now be used to control almost anything, reflecting its popularity in theaters and other venues.

DMX512 employs EIA-485 differential signaling at its physical layer, in conjunction with a variable-size, packet-based communication protocol. It is unidirectional.

DMX512 does not include automatic error checking and correction, and so is not an appropriate control for hazardous applications.

In 1998 the Entertainment Services and Technology Association (ESTA) began a revision process to develop the standard as an ANSI standard. The resulting revised standard, known officially as “Entertainment Technology—USITT DMX512-A-Asynchronous Serial Digital Data Transmission Standard for Controlling Lighting Equipment and Accessories”, was approved by the American National Standards Institute (ANSI) in November 2004. It was revised again in 2008, and is the current standard known as “E1.11—2008, USITT DMX512-A”, or just “DMX512-A”.

In January 2011 ESTA merged with PLASA, a similar organization in the UK. The new organization is called Plasa. All ESTA standards are now maintained by Plasa.

A standard deployment of a DMX512 network employs a multi-drop bus topology with nodes strung together in what is commonly called a daisy chain. A network consists of a single DMX512 controller—which is the master of the network—and one or more slave devices. For example, a lighting console is frequently employed as the controller for a network of slave devices such as dimmers, fog machines and intelligent lights.

Each slave device has a DMX512 “IN” connector and usually an “OUT” (or “THRU”) connector as well. The controller, which has only an OUT connector, is connected via a DMX512 cable to the IN connector of the first slave. A second cable then links the OUT or THRU connector of the first slave to the IN connector of the next slave in the chain, and so on. For example, the block diagram below shows a simple network consisting of a controller and three slaves.

The specification requires a ‘terminator’ to be connected to the final OUT or THRU connector of the last slave on the daisy chain, which would otherwise be unconnected. A terminator is a stand-alone male connector with an integral 120 Ω resistor connected across the primary data signal pair. This resistor matches the cable's characteristic impedance. If a secondary data pair is used, a termination resistor is connected across it as well. Although simple systems (i.e., systems having few devices and short cables) may sometimes function normally without a terminator, the standard requires its use. Some DMX slave devices have built-in terminators that can be manually activated with a mechanical switch or by software, or by automatically sensing the absence of a connected cable.

A DMX512 network is called a “DMX universe”. Each OUT connector on a DMX512 controller can control a single universe. Smaller controllers may have a single OUT connector, enabling them to control only one universe, whereas large control desks (operator consoles) may have the capacity to control multiple universes, with an OUT connector provided for each universe.

DMX512 data are transmitted over a differential pair using EIA-485 voltage levels. DMX512 electrical specifications are identical to those of the EIA-485-A standard, except where stated otherwise in E1.11.

DMX512 is a bus network no more than 1,200 meters (3,900 ft.) long, with not more than 32 unit loads on a single bus. If more than 32 unit loads need to communicate, the network can be expanded across parallel buses using DMX splitters. Network wiring consists of a shielded twisted pair, with a characteristic impedance of 120 Ohms, with a termination resistor at the end of the cable furthest from the controller to absorb signal reflections. DMX512 has two twisted pair data paths, although specification currently only defines the use of one of the twisted pairs. The second pair is undefined, but required by the electrical specification.

Alternatively, the present invention may employ a DMX over Ethernet protocol to extend the number of DMX universes and channels that can be controlled from a centralized Lighting Controller 133.

Due to the layered structure of the TCP/IP protocol suite that makes up the transmission standard used on Ethernet networks, multiple, unrelated pieces of data are sent down the same network. Tracking backup information such as lighting program parameters, firmware updates, RDM (Remote Device Management) information, and much more can be run down the one network, without any of the costly, time-consuming cable re-arrangement that is normally required when a lighting system's programmed configuration is changed

A significant benefit of Ethernet is its “star-topology” wiring layout. While DMX uses a “daisy-chaining” method, the star-topology of Ethernet leads to a much more robust network. The lack of daisy-chaining support may seem like a disadvantage at first, but the extra resilience of a network utilizing a star-topology means a fault in a device or cable may generally have a much smaller impact over the whole network and make it easier to trace. This coupled with the lower cost of cable may make a network utilizing Ethernet a safer, more robust system than anything built using the DMX protocol. The lack of “inputs” and “outputs” in Ethernet means plug any device, be it a console or fixture, into any port without needing to worry about the direction of travel. All devices may automatically communicate with each other as required, as a result of the TCP/IP protocol suite.

One of the most under-estimated advantages of a DMX over Ethernet implementation is Ethernet's ability to leverage the wide range of technologies developed by the IT industry. Inexpensive, yet highly reliable switches and cables can be used and there's a host of sub-protocols supported by most switches. An example of this would be Spanning Tree Protocol (IEEE 802.1D) which allows redundant links between switches such that should one go down for whatever reason, the other can take over seamlessly. Another useful technology is Virtual LANs, or VLANs (IEEE 802.1Q) which allows multiple venues all on the one network to segment the network into discrete virtual networks, guaranteeing no inadvertent control of one room from another. Streaming ACN makes use of the multicasting protocol to intelligently route universes of DMX only where it's required, with no manual reconfiguration. All of these features come in commonly available switches that are extremely reliable and often available much cheaper than the largely featureless DMX splitters in use today.

There is not yet a universal agreement between manufacturers as to which DMX-over-Ethernet protocol to use. Some protocols are fairly open and used by many manufacturers, while others remain proprietary and are typically only used by the manufacturer that developed them. There are typically five main protocols: ArtNet, Pathport, ShowNet, ETC Net2 and Streaming ACN.

ArtNet is a simple protocol designed purely for encapsulating DMX data within Ethernet, nice and simply. ArtNet has introduced the lighting world to DMX-over-Ethernet and is the most widely used DMX-over-Ethernet protocol in use today. However, there are some constraints that may limit its long-term usefulness. The numbering of universes from 0 rather than 1 is not very user-friendly, and can lead to confusion and incompatibility between manufacturers. Similarly, the lack of support for multicasting can make its transmission inefficient in large events utilizing many universes. For these and other reasons, ArtNet's future is in doubt against the more robustly defined Streaming ACN protocol.

Pathport, ShowNet and ETC Net2 are protocols designed by Pathway, Strand and ETC respectively. Their penetration is not as wide-spread as ArtNet, but they are used by a few consoles and devices. The Pathport protocol is supported by both MA's GrandMA and Jands' Vista for example, while Strand's ShowNet is the only protocol available in their 300 and 500 series desk. ETC Net2 is the protocol used for ETC's previous generation of consoles.

Streaming ACN is probably the best DMX-over-Ethernet protocol available. Not only does it avoid some of the pitfalls of its predecessors, but it also adds some new features that extend the functionality allowed in DMX. This feature allows visualization software to use a different stream of DMX than that is being used by the dimmers and fixtures, embedded priority information and an “end-of-sequence” function.

One of the most important things to consider in designing a DMX-over—Ethernet protocol is the range of DMX-over-Ethernet protocols supported. While most support ArtNet, currently the most popular protocol, there is still a significant amount of equipment out there that does not support ArtNet. Streaming ACN may become the preferred protocol driving lighting equipment. Pathport nodes are unique in the large range of protocols they support. ArtNet, Pathport, ShowNet, ETC Net2 and Streaming ACN (ETC Net3) are all supported by Pathway's Pathport nodes.

The best approach for DMX and Ethernet protocol is with infrastructure that is entirely Ethernet based. This allows DMX-to-Ethernet nodes to be placed where required that convert the DMX-over-Ethernet signal to legacy DMX for only the last couple of meters to the lights. It's generally important to feed more than one run of Ethernet to a specific location so there is not only one for a DMX-to-Ethernet node, but also for native Ethernet devices, such as configuration devices and future devices to plug directly in. Some nodes allow their ports to be configured as either output or input, regardless of the gender of the physical port. This allows a node typically used for output to become an input node with no more hardware except a simple gender-changer adaptor.

Lighting Controller 133 can receive data from Switches and Sensors 162 to turn on, turn off, or dim LED 140A, B, and/or LED 141A, B, and/or LED 142A, B.

Controller 132 also includes Shared Memory 134, and optional Industrial Controller 135.

Shared Memory 134 is an electronic data storage device, implemented on a semiconductor-based integrated circuit. It is made in many different types and technologies.

Semiconductor memory has the property of random access, which means that it takes the same amount of time to access any memory location, so data can be efficiently accessed in any random order. In a semiconductor memory chip, each bit of binary data is stored in a tiny circuit called a memory cell consisting of one to several transistors. The memory cells are laid out in rectangular arrays on the surface of the chip. The 1-bit memory cells are grouped in small units called words which are accessed together as a single memory address. Memory is manufactured in word length that is usually a power of two, typically N=1, 2, 4 or 8 bits.

Data is accessed by means of a binary number called a memory address applied to the chip's address pins, which specifies which word in the chip is to be accessed. If the memory address consists of M bits, the number of addresses on the chip is 2M, each containing an N bit word. Consequently, the amount of data stored in each chip is N2M bits. The memory storage capacity for M number of address lines is given by 2M, which is usually in power of two: 2, 4, 8, 16, 32, 64, 128, 256 and 512 and measured in kibibits, mebibits, gibibits or tebibits, etc. Currently 2014 is the largest semiconductor memory chip and holds a few gibibits of data, but higher capacity memory is constantly being developed. By combining several integrated circuits, memory can be arranged into a larger word length and/or address space than what is offered by each chip, often but not necessarily a power of two.

The two basic operations performed by a memory chip are “read”, in which the data contents of a memory word is read out (nondestructively), and “write” in which data is stored in a memory word, replacing any data that was previously stored there. To increase data rate, in some of the latest types of memory chips such as DDR SDRAM multiple words are accessed with each read or write operation.

In addition to standalone memory chips, blocks of semiconductor memory are integral parts of many computer and data processing integrated circuits. For example the microprocessor chips that run computers contain cache memory to store instructions awaiting execution.

Shared Memory 134 is used by both the Lighting Controller 133, and the optional Industrial Controller 135. Shared Memory 134 is used to store data necessary for the semi-automatic, or automatic, control of the LaaS and MaaS system. This data can include, but is not limited to, patient identity, medical worker identity, office employee identity, maintenance personnel identity, student identity, teacher identity, security personnel identity, building type, space type, room type, LED fixture voltage, LED fixture amperage, LED lumens, LED fixture type, LED fixture height above floor, LED fixture height above work surface, ambient light condition measurements and triggers motion measurements, occupancy measurements, vacancy measurements, humidity measurements, temperature measurements, air quality measurements, soil condition measurements, leaf wetness measurements, time-of-day, day-of-week, holiday schedules, building operational schedules, peak demand requirements, HVAC thermostat measurements, refrigerator measurements, baking oven measurements, point-of-sale system measurements, WiFi measurements, Bluetooth measurements, mobile device app measurements, facial expression measurements, location measurements, license plate reader readings, RFID tag readings, temporary over-ride measurements, lighting system wall switch signal measurements, non-linear dimmer matrices, etc.

Lighting Controller 133 and optional Industrial Controller 135 can also use data stored on Internet 100 and/or Hybrid Cloud 101 and/or Hybrid Cloud 102 to semi-automatically and automatically control LED 140A, B, LED 141A, B, and LED 142A, B, and Relays, PLCS, Solenoids 161. This data includes, but is not limited to, patient identity, medical worker identity, office employee identity, maintenance personnel identity, student identity, teacher identity, security personnel identity, building type, space type, room type, LED fixture voltage, LED fixture amperage, LED lumens, LED fixture type, LED fixture height above floor, LED fixture height above work surface, ambient light condition measurements and triggers, motion measurements and triggers, occupancy measurements and triggers, vacancy measurements and triggers, humidity measurements and triggers, temperature measurements and triggers, air quality measurements and triggers, soil condition measurements and triggers, leaf wetness measurements and triggers, time-of-day triggers, day-of-week triggers, holiday schedules, building operational schedules, peak demand requirements and triggers, HVAC thermostat measurements and triggers, refrigerator measurements and triggers, baking oven measurements and triggers, point-of-sale system measurements and triggers, WiFi measurements and triggers, Bluetooth measurements and triggers, mobile device app measurements and triggers, facial expression measurements and triggers, location measurements and triggers, license plate reader readings and triggers, RFID tag readings, measurements and triggers, temporary over-ride measurements and triggers, lighting system wall switch signal measurements and triggers, non-linear dimmer matrices, etc.

Controller 132 also includes an optional Industrial Controller 135. Optional Industrial Controller 135 is designed to control Relays, PLCs, and Solenoids 161.

Line Card 136A, B, C is a printed circuit board that provides transmitting/receiving ports for data, and power transmission over the Intelligent Lighting Network of the present invention. The Line Cards 136A, B, C plug into a modular chassis (not shown) of the Power Station 130.

Line Card 136A, B, C also includes Power Conditioning Modules 137A, B, C respectively. The Power Conditioning Modules 137A, B, C convert the standard electrical output of PoE, PoE+, or PoE++, or non-standard PoE versions to the proper voltage and amperage required to power LED 140A, B, or LED 141A, B, or LED 142A, B. One advantage of the present invention's Power Station 130 is it is LED fixture agnostic, and LED fixtures from different manufacturers can be powered on the same Intelligent Lighting Network by the same Power Station 130.

Line Card 136 A, B, C also includes Micro-Controller 138A, B, and C. Micro-Controller 138A, B, C is configured to respond to DMX512 commands for stacking two channels on top of each other, delivered on a single Output Power Port 180A, B, C, D, E, F, G, H, Ito power at least one LED 140A, B, or LED 141A, B, or LED 142A, B. In addition, Micro-Controller 138A, B, C is configured to respond to DMX512 commands to connect a multiplicity of DMX channels to a multiplicity of Output Power Ports 180A, B, C, D, E, F, G, H, I.

Line Card 136A, B, C may be configured in a variety of form factors, including, but not limited to, a small box for managing and distributing power that is located near LED 140A, B, LED 141A, B, and LED 142A, B, or in the form of an electrical wall outlet that is located near a free-standing, or mobile, lamp fixture that is designed to accept incandescent or CFL bulbs, etc.

In the present invention, the incandescent or CFL bulbs would be replaced with LED screw-based bulbs.

Using Line Card 136A, B, C configured as both a small box for managing and distributing power that is located near LED 140A, B, LED 141A, B, and LED 142A, B, and in the form of an electrical wall outlet that is located near a free-standing, or mobile, lamp fixture that is designed to accept incandescent or CFL bulbs, etc., a hybrid PoE-powered system that allows for a wide variety of aesthetically pleasing free-standing, or mobile, lamp fixtures to be used in conjunction with edge-light LED Flat Panels, reflective LED troffers, LED recessed lights, etc.

Line Card 136A, B, C (not shown) can include wireless capabilities, such as, but not limited to, WiFi, Zigbee, Z-Wave, etc. to enable communications with wireless capabilities (not shown) in Controller 132. The wireless communications can be used to turn lights on, off, or dim. In addition, the Line Card 136A, B, C configured as at least one electrical wall outlet that is located near a free-standing, or mobile, lamp fixture that is includes screw-based LED lights can be grouped logically together by Controller 132, and controlled as group, or according to triggers from Switches and Sensors 162.

LED 140A, B, LED 141A, B, and LED 142A, B are fixtures that produce light via a light-emitting diode (LED). LED lamps have a lifespan and electrical efficiency that is several times better than incandescent lamps, and significantly better than most fluorescent lamps, with some chips able to emit more than 100 lumens per watt.

Like incandescent lamps and unlike most fluorescent lamps (e.g. tubes and compact fluorescent lamps or CFLs), LEDs come to full brightness without need for a warm-up time. The life of fluorescent lighting is also reduced by frequent switching on and off.

Some LED lamps are made to be a direct compatible drop-in replacement for incandescent or fluorescent lamps. The LED lamp packaging may show the lumen output, power consumption in watts, color temperature in kelvins or description (e.g. “warm white”), operating temperature range, and sometimes the equivalent wattage of an incandescent lamp of similar luminous output.

Most LEDs do not emit light in all directions, and their directional characteristics affect the design of lamps, although omnidirectional lamps which radiate light over a 360° angle are becoming more common. The light output of single LEDs is less than that of incandescent and compact fluorescent lamps. In most applications multiple LEDs are used to form a lamp, although high-power versions (see below) are becoming available.

LED chips need controlled direct current (DC) electrical power. An appropriate circuit is required to convert alternating current from the supply to the regulated low voltage direct current used by the LEDs. LEDs are adversely affected by high temperature, so LED lamps typically include heat dissipation elements such as heat sinks and cooling fins.

AutoID 150A, B, C, D, E, F (aka Automatic Identification and Data Capture (AIDC)) refers to the methods of automatically identifying objects, collecting data about them, and entering that data directly into computer systems, without human involvement. Technologies typically considered as part of AIDC include bar codes, Radio Frequency Identification (RFID), biometrics, magnetic stripes, Optical Character Recognition (OCR), smart cards, and voice recognition. AIDC is also commonly referred to as “Automatic Identification,” “Auto-ID,” and “Automatic Data Capture.”

AIDC is the process or means of obtaining external data, particularly through analysis of images, sounds or videos. To capture data, a transducer is employed which converts the actual image or a sound into a digital file. The file is then stored and at a later time it can be analyzed by a computer, or compared with other files in a database to verify identity or to provide authorization to enter a secured system. Capturing of data can be done in various ways and the best method depends on application.

AIDC also refers to the methods of recognizing objects, getting information about them and entering that data or feeding it directly into computer systems without any human involvement. Automatic identification and data capture technologies include barcodes, RFID, barcodes, OCR, magnetic stripes, smart cards and biometrics (like iris and facial recognition system).

Radio frequency identification (RFID) is relatively a new AIDC technology which was first developed in 1980s. The technology acts as a base in automated data collection, identification and analysis systems worldwide.

RFID and barcodes are the primary AutoID (aka AIDC) technologies that would be used to mark LED 140A, B, LED 141A, B, and LED 142A, B.

In the present invention, AutoID 150A, B, C, D, E, F configured as RFID tags would be used during installation to capture the ID of the light and its physical location by RFID triangulation. These identities and locations would be compared to the RCP (Reflected Ceiling Plan) for the installation. In this manner, the Intelligent Lighting Network System may become self-aware, and capable of becoming self-configuring. The DMX channels for a light, or string of lights, can be assigned on-the-fly. In addition, during installation, Lighting Controller 133 can access tables in Shared Memory 134 that define national and local code lighting levels for various building types, and spaces, and room types. Using the lighting systems sensors in Switches and Sensors 162 the Intelligent Lighting Network System can be configured and adjusted automatically.

Access Point 160 is a WiFi access point that is used to communicate wireless with the Intelligent Lighting Network System, and to monitor WiFi Radio MAC addresses. In addition, Access Point 160 includes a Bluetooth Radio that can monitor Bluetooth Radio MAC addresses. One example of such an Access Point 160 is the Meraki MR series, which tracks probing MAC addresses from associated and non-associated clients. This data is exported in real time from the access points to Meraki's cloud for analytics. Information is then calculated and presented in the Meraki dashboard to display metrics such as user dwell-time, repeat visits and capture rate (people passing by vs. coming inside a site). This information can be used by retailers, hospitality, and enterprise customers to understand foot traffic and visitor behavior across sites, and can facilitate an optimization of opening hours, marketing initiatives, and staffing policies.

Digital Signage and Marketing System 163 is comprised of digital signs (not shown), digital advertising and messaging players (not shown), client GUIs (not shown), customer GUIs (not shown), cameras (not shown), optional kiosks (not shown), social media marketing engine (not shown), and apps for receiving coupons, discounts, and offers generated by the Digital Signage and Marketing System 163.

Cables 190A, B, C, D, E, F, G, H, I, J, K, L M, N, O, P, Q are used in electrical and electronic systems for transmitting electric power or telecommunication signals from one place to another. Cables 190A, B, C, D, E, F, G, H, I, J, K, L M, N, O, P, Q are made-up of one or more conductors. Electric communication cables transmit voice messages, computer data, and visual images via electrical signals to telephones, wired radios, computers, teleprinters, facsimile machines, and televisions. There is no clear distinction between an electric wire and an electric cable. Usually the former refers to a single, solid metallic conductor, with or without insulation, while the latter refers to a stranded conductor or to an assembly of insulated conductors.

Wireless Connection 190R illustrates a wireless connection from the AutoID 150A, B, C, D, E, and F to a wireless access point, which can be configured, such as, but not limited to, an RFID interrogator.

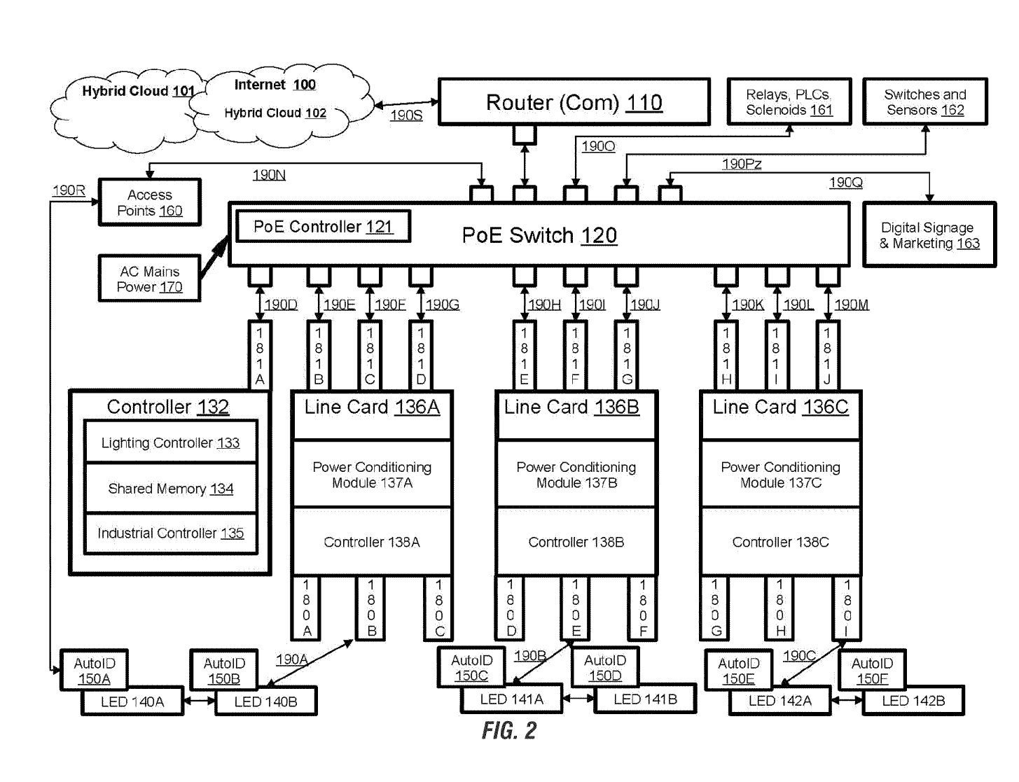

FIG. 2 is an illustration of an alternative embodiment of the present invention in which the Power Station 130 as illustrated in FIG. 1 is broken into separate components, which include Controller 132, Lighting Controller 133, Shared Memory 134, and optional Industrial Controller 135 which are integrated in a rack-mountable chassis, and Line Cards 136A, B, C which are packaged as separate devices. The like-identified elements in FIG. 1 and FIG. 2 have previously been described in FIG. 1.

It is important to note that Line Card 136A, B, C illustrated in FIG. 2 may be configured in a variety of form factors, including, but not limited to, a small box for managing and distributing power that is located near LED 140A, B, LED 141A, B, and LED 142A, B, or in the form of an electrical wall outlet that is located near a free-standing, or mobile, lamp fixture that is designed to accept incandescent or CFL bulbs, etc.

In the present invention, the incandescent or CFL bulbs would be replaced with LED screw-based bulbs.

Using Line Card 136A, B, C configured as both a small box for managing and distributing power that is located near LED 140A, B, LED 141A, B, and LED 142A, B, and in the form of an electrical wall outlet that is located near a free-standing, or mobile, lamp fixture that is designed to accept incandescent or CFL bulbs, etc., a hybrid PoE-powered system that allows for a wide variety of aesthetically pleasing free-standing, or mobile, lamp fixtures to be used in conjunction with edge-light LED Flat Panels, reflective LED troffers, LED recessed lights, etc.

Line Card 136A, B, C (not shown) can include wireless capabilities, such as, but not limited to, WiFi, Zigbee, Z-Wave, etc. to enable communications with wireless capabilities (not shown) in Controller 132. The wireless communications can be used to turn lights on, off, or dim. In addition, the Line Card 136A, B, C configured as at least one electrical wall outlet that is located near a free-standing, or mobile, lamp fixture that is includes screw-based LED lights can be grouped logically together by Controller 132, and controlled as group, or according to triggers from Switches and Sensors 162.

The following description is a practical example of how the present invention for powering and communicating with an intelligent lighting system operates in a small footprint building, such as a Quick Service Restaurant (QSR) setting.

An employee enters the building and turns a wall switch (Switches and Sensors 162) located near the door, as required by building codes, from the ‘OFF’ position to the ‘ON’ position.

A signal in the form of a data is sent via cable 190Q to PoE Switch 120 which includes a code for “ON” and the electronic identity of the wall switch. A Cable 190Q is the preferred physical medium for transmitting the ‘ON’ data signal, but it should be noted that a wireless channel, such as WiFi, Bluetooth, Zigbee, etc., are also acceptable means for communication.

The data signal is routed to the circuit boards for Controller 132 and Lighting Controller 133 via cable 190D and Input Power and Data Port 181A.

The program operating the intelligent lighting system on Lighting Controller 133 receives the data signal wall switch to turn “ON” the lights. The lighting system program accesses various data tables in Shared Memory 134 to cross-reference the electronic identity of the wall switch against which LEDs 140A, B, 141A, B, 142A, B are grouped together logically as a lighting circuit. The lighting system program also accesses data tables in Shared Memory for actions to take for the appropriate dim level according to some, or all, of the following tables with associated triggers and instructions: time-of-day, day-of-week, holiday schedule, ambient light conditions as detected by ambient light sensors (Switches and Sensors 162), motion as detected by motion sensors (Switches and Sensors 162), occupancy and vacancy as calculated by motion data, the maximum dim setting selected from a group consisting of: minimum light settings according to national and local buildings codes, minimum light settings according to OSHA, minimum light settings according to various standards organizations, minimum light settings according to insurance company requirements, and minimum light settings according to building owner requirements, AutoID 150A, B, C, D, E, F data signals consisting of serial numbers related to various LED 140A, B (Mfg. A), LED 141A, B (Mfg. B), LED 142A, B (Mfg. C) received via Wireless Connection 190R of which the data consists of dimmer matrices for each SKU that include Pulse Width Modulation Duty Cycles matched to the desired light outputs, and logical circuits which include SKU vs. Output Power Ports 180A, B, C, D, E, F, G, H, I vs. LED 140A, B (Mfg. A), LED 141A, B (Mfg. B), LED 142A, B (Mfg. C).

Lighting Controller 133 uses all available data to intelligently select the correct Pulse Width Modulation duty cycle setting that is required for each LED 140A, B (Mfg. A), LED 141A, B (Mfg. B), LED 142A, B (Mfg. C), and which physical channels to distribute power over to the various lights LED 140A, B (Mfg. A), LED 141A, B (Mfg. B), LED 142A, B (Mfg. C) in the lighting network.

The Power Bus and Back-plane 131 supplies power and routes data to Line Cards 136A, B, C.

Lighting Controller 133 communicates with the Power Conditioning Modules 137A, B, C, on Line Cards 136A, B, C the correct DC volt and amperage settings according the SKU of each LED 140A, B (Mfg. A), LED 141A, B (Mfg. B), LED 142A, B (Mfg. C). In addition, Lighting Controller 133 communicates with Microcontrollers 138A, B, C on Line Cards 136A, B, C, the correct PWM duty cycle settings for each physical channel that is connected to Output Power Ports 180A, B, C, D, E, F, G, H, I that are connected to LED 140A, B (Mfg. A), LED 141A, B (Mfg. B), LED 142A, B (Mfg. C).

The intelligent lighting back-end system can store relevant lighting system data tables in Hybrid Cloud 101 and/or Hybrid Cloud 102 located on Internet 100 via Router 100. The intelligent lighting system also includes at least one Access Point 160 so mobile users can control the system via apps on mobile phones and tablets.

The present invention's network gear can also be used to power Digital Signage and Marketing systems 163.

Lastly, the present invention's Optional Industrial Controller 135 is programmed to use Shared Memory 134 to access parameters, data, electronic identities, and triggers to control Relays, PLC's, and Solenoids 161 that may be connected to walk-in coolers, oven belt speeds and temperatures, HVAC thermostats, etc.

In addition, the previously described low voltage system for lighting that manages power horizontally and vertically, can be configured for use as a security system as well.

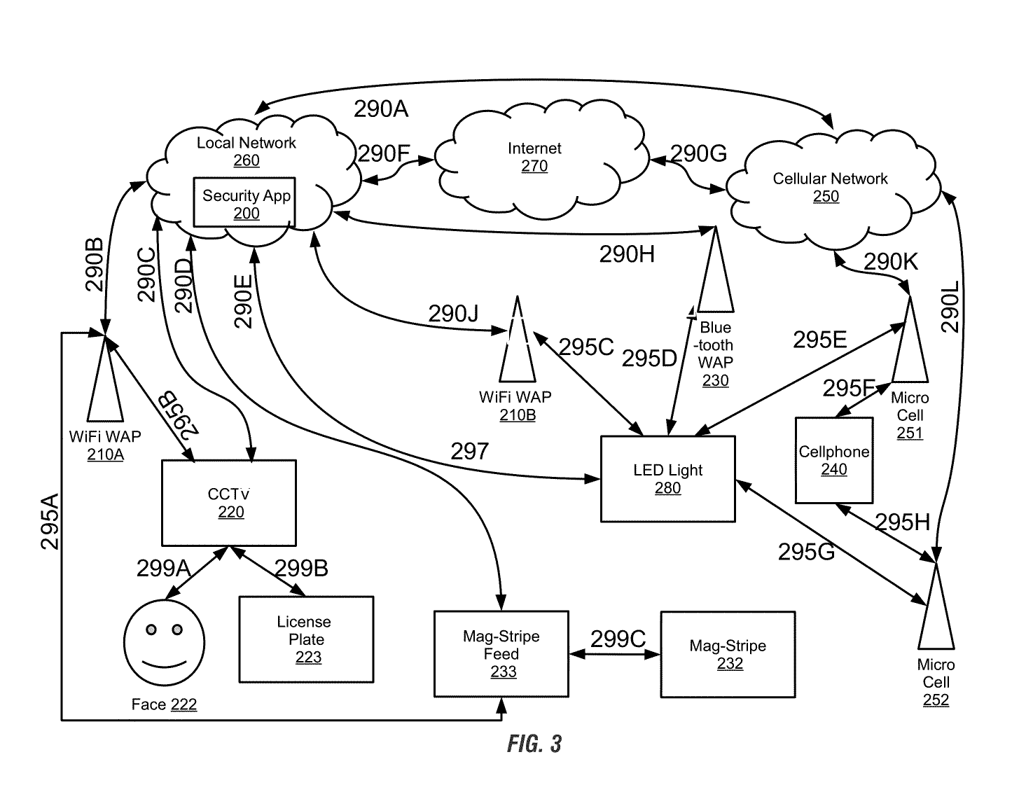

FIG. 3 is an illustration of the present invention, which consists of elements described below. Security app 200 is a software application that includes all the computer software to perform all the tasks associated with the present invention. Security app 200 operates on a programmable machine designed to sequentially and automatically carry out a sequence of arithmetic or logical operations. The programmable machine consists of some form of memory for data storage, at least one element that carries out arithmetic and logic operations, and a sequencing and control element that can change the order of operations based on the information that is stored. Alternatively, security app 200 may partially run on firmware, or be embedded in hardware.

One task that security app 200 may be running is an optional computer application for automatically identifying or verifying a person from a digital image or a video frame from a video source, which is commonly known as facial recognition. Security app 200 would analyze an image of selected facial features and compare them to an image and a facial features database. Security app 200 could also be used for other biometrics, such as, but not limited to, fingerprint, or voice, or eye iris recognition systems.

Another task security app 200 may be running is an optional Automatic Number Plate Recognition (ANPR) system, which is a surveillance method that uses optical character recognition (OCR) to decode the alphanumerics on vehicle license plates, which are also known as vehicle registration plates.

The software required to run an ANPR system uses 1) a series of image manipulation processing techniques to detect, normalize and enhance the image of the license plate, and 2) an optical character recognition (OCR) to extract the alphanumerics of the license plate.

An ANPR system can be used to store the images captured by the cameras as well as the decoded alphanumerics from the license plate, which may be cross-linked to an image of the driver, email addresses, telephone numbers, street address, mailing address, GPS location, time and date information, make, model, and color of the vehicle, student identification photo and information, employee identification photo and information, etc. The camera used to capture the image of the license plate, or registration plate, may also include infrared lighting so the camera can take a picture any time of the day.

CCTV (Closed-Circuit TV) Camera 220 is used to acquire images, and is connected to a network, such as, but not limited to, a point-to-point network, a mesh network, etc., to transmit encoded signals to a digital video recorder data storage system, and/or a defined set of monitors. CCTV Camera 220 can be an IP-based camera, which may be equipped with megapixel sensors. Only one CCTV Camera 220 is illustrated, but it will be apparent to one skilled in the art that the present invention's advanced security system can employ a multiplicity of cameras.

In addition to capturing fixed fields of view, CCTV Camera 220 can be configured as PTZ (pan, tilt, zoom) cameras to increase the area of visual coverage of any particular camera. CCTV Camera 220 can operate from a fixed point in space, or a mobile point in space.

CCTV Camera's 220 captured images can be analyzed by an application configured as software, firmware, and embedded in hardware that is capable of isolating at least one license plate 223, and/or at least one face 222, and/or motion 221 across the field of view, and/or ambient light intensity, temperature, the color rendering index (CRI), lumens, etc., color, make, and model of a vehicle, 1D and 2D bar codes, such as, but not limited to, Code 39, Code 39 extended, Danish PTT 39 Bar code, French Postal 39 A/R, German Postal Bar code Identcode 11, German Postal Bar code Leitcode 13, 2 of 5 Interleaved, 2 of 5 Industrial, of 5 Matrix Plessey, Codabar, MSI Plessey, MSI Plessey+CHK10, MSI Plessey+CHK10+CHK10, MSI Plessey+CHK11+CHK10, 2 of 5 IATA, 2 of 5 Datalogic, Code 39 Reduced, USPS tray label, USPS sack label, Code32, Codabar Rationalised, MSI Plessey+CHK11, OMR, Code 93, Code 93 extended, 128 A, 128 B, 128 C, UCC-128, EAN/JAN-8, EAN/JAN-8+2, EAN/JAN-8+5, EAN/JAN-13, EAN/JAN-13+2, EAN/JAN-13+5, UPC-A, UPC-A+2, UPC-A+5, UPC-E, UPC-E+2, UPC-E+5, Oce UNICODE, 128 utoswitch, EAN 128, ISBN, ISSN, Swiss Postal, Code11, UPS Standard (18 digits), UPS 18 digits, UPS Standard (11 digits), UPS 11 digits, 128 X (Free Type), Telepen, PDF-417, PDF-417 (HP Mode), MicroPDF417, Royal Mail 4-State Customer Code, Dutch 4-State Postal, Singapore Post 4-State Postal Code, Australia Post 4-State Postal Code, Japan Post 4-State Postal Code, Australia Post 4-State Postal Code 37,52,67, Australia 4-state postal 37-GUST (HP Mode), Australia 4-state postal 52-FF-MET (HP Mode), Australia 4-state postal 67-FF-MET (HP Mode), Australia 4-state postal FCC-45 REPLY (HP Mode), Singapore Post 4-State Postal Code (HP Mode), DataMatrix, MaxiCode, MaxiCode (HP Mode), USPS FIM, POSTNET 5 ZIP+4, POSTNET 9 ZIP+4, POSTNET 11 DPC, PLANET, Aztec, Aztec Mesas, QR Code, Code 49, Channel Code, Code One, SuperCode, RSS, EAN/UCC Composite Symbology, Codablock F, Dot Code A, Code16K.

These aforementioned bar codes may also use data tags as an integral part of the source data, which can be used to facilitate the input of data into an electronic document, and/or back-end system, and/or software application, and/or firmware, and/or embedded hardware. Primarily within the present invention, data tags are an integral part of the data that has been summed up and displayed in at least one 1D and/or 2D bar codes by a software app, firmware, or embedded hardware, in order to facilitate data interchange to targeted software applications and/or devices. Also, embedded data tags in bar codes may be used by a targeted software app, and/or targeted firmware, and/or targeted embedded hardware, to facilitate various activities, such as, but not limited to, raising or lowering a security gate, unlocking a door, initiating an image capture of a face 222 or license plate 223, launching a web page, etc.

Security app 200 can operate private cellular network software such as, but not limited to, the Quortus EdgeCentrix Platform. The Quortus EdgeCentrix Platform combines all the main elements of a GSM and 3G core network that traditionally would take up several racks worth of equipment into a compact software application. The essential functionality of an HLR/AuC, MSC, SMSC, femto gateway and SGSN/GGSN are all included to create a private cellular network ready for standalone use or for interconnect into IP-PBXs or the PSTN using SIP.

The Quortus EdgeCentrix Platform supports a range of GSM, 3G UMTS and 4G radio transmitters from a range of vendors, giving unique flexibility for a single core network package. Multiple transmitters may be supported on one core, even from different types—for example, GSM picocells and 3G femtocells (illustrated in FIG. 3 as Micro Cell 251) maybe supported simultaneously and calls made seamlessly between them.

The Quortus EdgeCentrix Platform can run on standard Intel PC servers for higher capacity, on embedded ARM processors where small physical size and low power consumption is important and also as an application on the Cisco ISR router SRE modules, for close integration with enterprise voice networks.

Face 222 is a human face, which includes features such as, but not limited to, hair, foreheads, eyebrows, eyelashes, eyes, nose, ears, cheeks, mouths, lips, philtrum, temples, teeth, skin, and chins. In addition, the face 222 is capable of various expressions that make it unique. Face 222 can be captured electronically, analyzed, and correlated to a database in order to be identified within a surveillance network to grant or deny access, to grant or deny permission, etc. Face 222 can be cross-correlated to an email addresses, telephone numbers, street address, mailing address, GPS location, time and date information, make, model, and color of the vehicle, student identification photo and information, employee identification photo and information, etc.

License Plate 223 is a metal or plastic plate attached to a motor vehicle or trailer for official identification purposes. The registration identifier is a numeric or alphanumeric code that uniquely identifies the vehicle within the issuing region's database. In some countries, the identifier is unique within the entire country, while in others it is unique within a state or province. Whether the identifier is associated with a vehicle or a person also varies by issuing agency. Depending on the country, the vehicle registration plate may also be known as license plates, license tags, number plates, or registration plates.

License plate 223 can be captured electronically, analyzed, and correlated to a database in order to be identified within a surveillance network to grant or deny access, to grant or deny permission, etc. License plate 223 can be cross-correlated to an image of the driver, email addresses, telephone numbers, street address, mailing address, GPS location, time and date information, make, model, and color of the vehicle, student identification photo and information, employee identification photo and information, etc.

Bluetooth WAP 230 wireless access point (WAP) that operates using the Bluetooth Low Energy (BLE) feature of the Bluetooth 4.0 protocol, which is a wireless radio technology aimed at new, principally low-power and low-latency, applications for wireless devices within a short range (up to 50 meters/160 feet). Bluetooth WAP 230 wireless access point can also operate as a sniffer only, which acquires the electronic signature and/or ID of Bluetooth-, or BLE-enabled devices operating with range.

Devices using BLE wireless technology consume a fraction of the power of classic Bluetooth enabled products for Bluetooth communication. One of the benefits of BLE is that in many cases, products will be able to operate more than a year on a button cell battery without recharging. It will allow sensors such as thermometers, and transponders to operate continuously, communicating intermittently with other devices, such as, but not limited to, cellphones, wireless access points, etc.

BLE's lower power consumption is not achieved by the nature of the active radio transport, but by the design of the protocol to allow low duty cycles, and by the use cases envisaged. A Bluetooth low energy device used for continuous data transfer would not have a lower power consumption than a comparable Bluetooth device transmitting the same amount of data. It would likely use more power, since the protocol is optimized for small bursts.

The wireless access point feature of BLE WAP 230 is used to connect wireless transmission to a wired network using the Bluetooth standards. The wireless access point can connect to a separate router on a wired network, or the router and wireless access point can be integrated into the same form factor.

In the context of the present invention, a wireless access point is being used to describe a connection point for a peer to peer wireless ad hoc network. Ad hoc networks use a connection between two or more devices without using what is normally called in industry, a wireless access point (WAP).

A wireless ad hoc network is a decentralized wireless network. The network is ad hoc because it does not rely on a preexisting infrastructure, such as routers in wired networks or access points in managed infrastructure wireless networks. Instead, each node participates in routing by forwarding data for other nodes, so the determination of which nodes forward data is made dynamically on the basis of network connectivity. In addition to the classic routing, ad hoc networks can use flooding for forwarding the data.

An ad hoc network typically refers to any set of networks where all devices have equal status on a network and are free to associate with any other ad hoc network device in link range. Ad hoc network often refers to a mode of operation of IEEE 802.11 wireless networks.

Ad hoc network also refers to an enabled device's ability to maintain link status information for any number of devices in a 1-link, also known as “hop” range, and thus, this is most often a Layer 2 activity. Because this is only a Layer 2 activity, ad hoc networks alone may, or may not support a route-able IP network environment without additional Layer 2 or Layer 3 capabilities.

The decentralized nature of wireless ad hoc networks makes them suitable for a variety of applications where central nodes can't be relied on and may improve the scalability of networks compared to wireless managed networks.

Minimal configuration and quick deployment make ad hoc networks suitable for emergency situations like natural disasters, military conflicts, or electronic surveillance systems being described within the present invention. The presence of dynamic and adaptive routing protocols enables ad hoc networks to be formed quickly.

Wireless ad hoc networks can be further classified by their application: Mobile Ad-Hoc Networks (MANET), Wireless Mesh Networks (WMN), Wireless Sensor Networks (WSN).

BLE WAP's 230 main function is to monitor the electronic serial number of a BLE device, and it's secondary function is to transceive data from a BLE enabled device. Therefore, BLE WAP 230 acts both as a wireless access point, and a peer to peer access point.

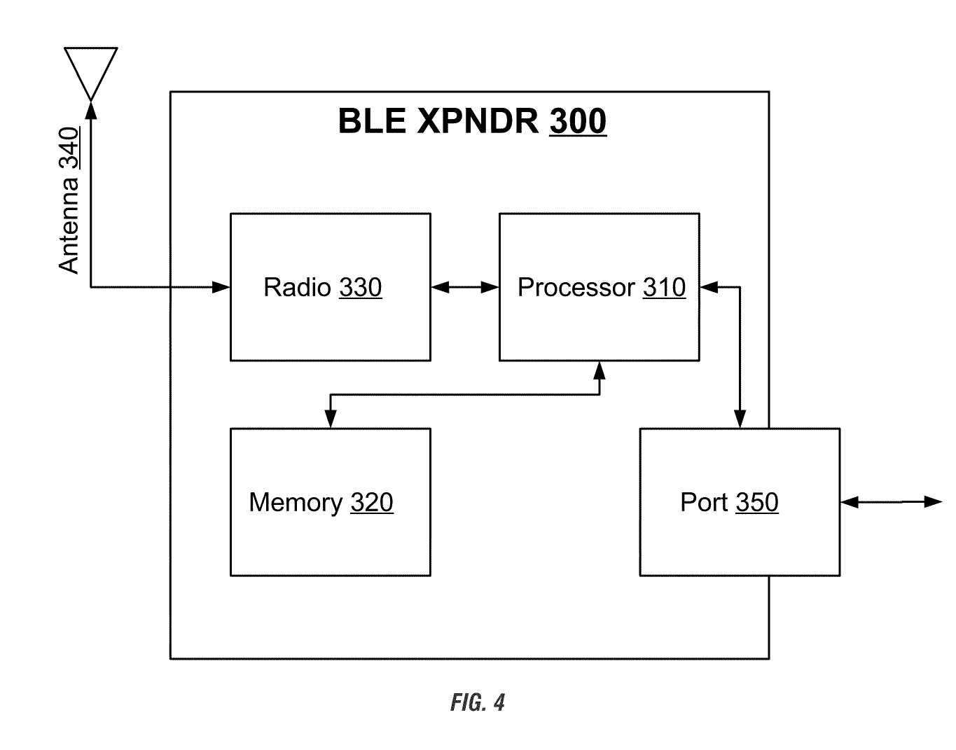

BLE XPNDR 300 (as illustrated in FIG. 4) regularly, or continuously emits an identifying electronic wireless signal, much like a transponder, of which the signal may be encrypted as necessary.

In addition, BLE XPNDR 300 (as illustrated in FIG. 2) functions as a magnetic stripe 232 reader. BLE XPNDR 300 is configured to transmit signals via the Bluetooth Low Energy protocol to other BLE XPNDR 300 (not shown) to a BLE WAP 230, or to a Bluetooth radio integrated into cellphone 240, in which case information contained in BLE XPNDR 300 can be transmitted via the cellphone 240 cellular radio (not shown), and/or cellphone 240 Wi-Fi radio (not shown), or can be presented as a mobile bar code on cellphone 240 display (not shown).

BLE XPNDR 300 (as illustrated in FIG. 4) can be located using a network of BLE WAP 230 devices.

Alternatively, BLE XPNDR 300 (as illustrated in FIG. 4) co-located with cellphone 240 can be located using a hybrid positioning network designed to locate a cellphone singularly, or via any combination of GPS triangulation, Wi-Fi WAP triangulation, and cell tower triangulation.

Alternatively, BLE XPNDR 300 (as illustrated in FIG. 4) can be located using a hybrid positioning network consisting of GPS triangulation, Wi-Fi WAP triangulation, cell tower triangulation, and BLE WAP network triangulation.

Alternatively, BLE XPNDR 300 can be configured to transmit and receive signals according to at least one protocol, such as, but is not limited to, MiWi, Wi-Max, CDMA, TDMA, RFID, Satellite, etc., to accomplish the goals of the present invention.

Mag-Stripe 232 is a magnetic stripe card capable of storing data by modifying the magnetism of tiny iron-based magnetic particles on a band of magnetic material on the card. The magnetic stripe, sometimes called swipe card or mag-stripe, is read by swiping past a magnetic reading head.

A number of International Organization for Standardization standards, ISO/IEC 7810, ISO/IEC 7811, ISO/IEC 7812, ISO/IEC 7813, ISO 8583, and ISO/IEC 4909, now define the physical properties of the card, including size, flexibility, location of the mag-stripe, magnetic characteristics, and data formats. They also provide the standards for financial cards, including the allocation of card number ranges to different card issuing institutions.

Mag-Stripe 232 may be located on an access badge as a credential used to gain entry to an area having automated access control entry points. Entry points may be doors, turnstiles, parking gates or other barriers.

The access badge contains a number that is read by a card reader. The number is sent to an access control system, a computer system that makes access control decisions based on information about the credential. If the credential is included in an access control list, the access control system unlocks the controlled access point. The transaction is stored in the system for later retrieval; reports may be generated that reveal who entered what controlled access point at what time.

Mag-Stripe 232 may be located on a smart card, also known as a chip card, or as an integrated circuit card (ICC), which is any pocket-sized card with embedded integrated circuits. Smart cards are made of plastic, generally polyvinyl chloride, but may also be constructed of polyethylene terephthalate-based polyesters, acrylonitrile butadiene styrenes, polycarbonates, etc.

Smart cards can provide identification, authentication, data storage and application processing. Smart cards may provide strong security authentication for single sign-on (SSO) within large organizations, such as, but not limited to, public schools, colleges, universities, government offices, corporations, etc.

Mag-Stripe 132 may also be located on an affinity card, which is designed for organizations to offer its members and supporters those who have an “affinity” for that organization. The affinity card may be configured such as, but not limited to, a debit or credit card branded with an organization's brand and imagery, a student identification card, or an employee identification card, etc.

Affinity debit and credit cards may be offered by many retailers, shopping centers, airlines, universities, alumni associations, sports teams, professional associations and others, and increasingly by small and mid-sized nonprofits and membership-based groups that rely on these programs for incremental revenue. Mag-Stripe Feed 233 can be inserted and read by BLE XPNDR 200.

Cellphone 140 may be configured as a smart-phone, which is a mobile phone built on a mobile operating system. Most modern smart-phones also include high-resolution touchscreens and web browsers that display standard web pages as well as mobile-optimized sites. High-speed data access is provided by Wi-Fi and mobile broadband. In recent years, the rapid development of mobile app markets and mobile commerce have been drivers of smart-phone adoption.

The mobile operating systems (OS) used by modern smart-phones include Google's Android, Apple's iOS, Nokia's Symbian, RIM's BlackBerry OS, Samsung's Bada, Microsoft's Windows Phone, Hewlett-Packard's webOS, and embedded Linux distributions such as Maemo and MeeGo. Such operating systems can be installed on many different phone models, and typically each device can receive multiple OS software updates over its lifetime. A few other upcoming operating systems are Mozilla's Firefox OS and Canonical Ltd.'s Ubuntu Phone.

Cellphone 240 typically includes a processor, which is at least one integrated circuit (IC) that accepts digital data as input, processes it according to instructions stored in its memory, and provides results as output. The processor is a sequential digital logic device that is operatively connected to memory, and at least one element carries out arithmetic and logic operations, and a sequencing and control element that can change the order of operations based on the information that is stored in the memory. The security app 200 is capable of communicating instructions to cellphone 240 via at least one type of wireless port (not shown).

Cellphone 240 includes memory (not shown), which is at least one physical device used to store programs (sequences of instructions) or data (e.g. program state information) on a temporary or permanent basis for use in controlling and interacting with security app 200, and/or BLE XPNDR 300.

Cellphone 240 memory is typically addressable semiconductor-based memory, such as, but not limited to, an integrated circuit. Cellphone 240 memory (not shown) can be primary and/or secondary memory. Furthermore, cellphone 240 memory (not shown) can be volatile and/or non-volatile memory. Cellphone 2400 memory (not shown) can be constructed using technologies such as, but not limited to, ROM, PROM, EPROM, EEPROM, RAM, DRAM, static RAM, static SRAM, etc.

Cellphone 240 typically also includes at least one non-voice wireless port (not shown) enabled to communicate via Wi-Fi, and/or Bluetooth, and a hardwire port.

Cellphone 240 non-voice wireless port(s) (not shown) can be configured and constructed to operate using a technology such as, but not limited to, Wi-Fi, Bluetooth, Bluetooth Low Energy (BLE), etc.

Wi-Fi 210A, 210B are Wi-Fi wireless access points that permit Wi-Fi-enabled devices to connect to the Internet when within range. In addition, Wi-Fi 210A, 210B can act as sniffers to acquire the electronic signature and ID of Wi-Fi-enabled devices operating within their range.

Wi-Fi can provide service in private homes, businesses, as well as in public spaces. Wi-Fi routers can be specified to incorporate a digital subscriber line modem or a cable modem.

Similarly, there are battery-powered routers that include a cellular mobile Internet radio-modem and Wi-Fi access point. When subscribed to a cellular phone carrier, they allow nearby Wi-Fi stations to access the Internet over 2G, 3G, or 4G networks. Many smartphones have a built-in capability of this sort, including those based on Android, Bada, iOS (iPhone), Windows Phone and Symbian,

“Internet pucks” provide standalone facilities of this type as well, without use of a smartphone; examples include the MiFi- and WiBro-branded devices. Some laptops that have a cellular modem card can also act as mobile Internet Wi-Fi access points.

Wi-Fi is a popular technology that allows an electronic device to exchange data wirelessly (using radio waves) over a network. In the broadest sense, Wi-Fi is defined as any wireless local area network (WLAN) product, or device, that is based on IEEE 802.11 standards. Wi-Fi can be used to interconnect devices, such as, but not limited to, personal computers, video-game consoles, video-game controllers, smart-phones, tablets, digital audio players, etc. Wi-Fi standards can be used to allow enabled devices to interconnect through a wireless access point, or peer-to-peer.

Bluetooth is a wireless technology standard for exchanging data over short distances using short-wavelength radio transmissions in the ISM band from 2400-2480 MHz from fixed and mobile devices, to create personal area networks (PANs) with high levels of security. Bluetooth can connect several devices, which overcomes the problems of synchronization.

Bluetooth Low Energy (BLE) is a feature of Bluetooth 4.0 wireless radio technology, aimed at new, principally low-power and low-latency, applications for wireless devices within a short range of up to 160 feet.

Bluetooth Low Energy technology (2.45 GHz) has become an attractive alternative to Near Field Communication (NFC 13.56 MHz) as a short-range communication technology, due to its low power consumption and greater range. Allowed transmission power for NFC 13.56 MHz is strongly limited, restricting range. In contrast to NFC, Bluetooth Low Energy has a range of 50 meters. Bluetooth Low Energy technology set-up time has been designed to be faster than classic Bluetooth technology.

Bluetooth Low Energy achieves its phenomenal success through the design of the protocol to allow low duty cycles.

Several chip suppliers have released Bluetooth Low Energy chips. Some of these offered chip designs include the entire protocol suite implementation, others allow for special implementing strategies. Some of these chip designs allow for dynamic change of protocol suites even outside the Bluetooth technology/Bluetooth Low Energy (BLE) standard, others are designed for a single protocol suite. Bluetooth Low Energy chipsets are available from companies such as, but not limited to, Broadcom, CSR, EM Microelectronic, Nordic Semiconductor, Texas Instruments, etc.

Cellphone 240 also includes a wireless port (not shown) for cellular communications, and can be configured and constructed to operate using a technology such as, but not limited to, GSM, CDMA, TDMA, etc. Voice and/or General Packet Radio Service (GPRS) data packets, can be transported over this type port.

Cellphone 240 hardwire port(s) (not shown) can be configured and constructed using a technology such as, but not limited to, USB, USB Type-A, USB Type-B, USB Mini A, USB Mini B, Micro-A USB, USB Micro B, eSATA, Firewire, Component Video, HDMI, DisplayPort, DVI, S-Video, VGA, etc.

Cellular Network 250 is a mobile network, which is a radio network distributed over land areas called cells, each served by at least one fixed-location transceiver, known as a cell site or base station. In a cellular network 250, each cell uses a different set of frequencies from neighboring cells, to avoid interference and provide guaranteed bandwidth within each cell.

When joined together these cells provide radio coverage over a wide geographic area. This enables a large number of portable transceivers (e.g., mobile phones, pagers, etc.) to communicate with each other and with fixed transceivers and telephones anywhere in the network, via base stations, even if some of the transceivers are moving through more than one cell during transmission.

Micro Cell 251 is a cell in a mobile phone network served by a low power cellular base station, covering a limited areas such as, but not limited to, a school campus, a business campus, a hotel, a parking lot, an airport, a train station, a high rise building, a bus, a train, etc. Micro Cell 251 is usually larger than a picocell, though the distinction is not always clear. Micro Cell 251 uses power control to limit the radius of its coverage area. A Micro Cellular network is a radio network composed of Micro Cells.

Typically the range of a Micro Cell 251 is less than two kilometers wide, whereas a standard base station in a cellular network may have ranges of up to 35 kilometers (22 mi). Picocells, on the other hand, is 200 meters or less, and a femtocell is on the order of 10 meters intelligent 3G and LTE small cells.

As an example, one company, Ubiquisys, provides Micro Cellular technology that includes the following features: ActiveRadio, RTM, Radio Resource Management—Unique radio resource algorithms, which mean that the unit(s) explore the radio environment to optimize the service provided within the home, while at the same time minimizing any possible disruption to the external macro network. These algorithms also enable full plug-and-play for the enterprise by providing the ability to activate and upgrade small cells remotely, without affecting service.

Provisioning And Automatic Setup—Small cells are pre-provisioned with basic configuration parameters, so they know who they are and who they belong to. Once plugged in at the enterprise, operator policies are downloaded and the small cells simply adjust the radio configuration according to local conditions, within these policies. They are then automatically activated in a matter of minutes.

Listen Mode, UL/DL Power Setting—The small cell contains a down-link Listen Mode, which measures the interference levels of surrounding macro and small cells. Using Listen Mode, the Small Cell selects the settings for optimal performance for users of the small cell, while minimizing the interference to the macro according to the operator's policies.

Dynamic Code and Down-link Power Reallocation—The small cell supports down-link power reallocation between individual data channels or between data channels and HSDPA.

Up/Down-link Power Adaptation—The small cell initially sets its power levels based on the received signal levels it experiences from the macro network, in order to minimize up-link interference, including adjacent channel interference mitigation. These values are then dynamically altered according to the actual levels reported by the end user device through measurement reports.

Continuous Fast Sniff—The small cell uniquely uses an active sniff mode during normal operation to monitor changes in the radio environment—without affecting calls.

Below is a brief summary of the key call features Ubiquisys Micro Cells support: 8/16-call, Video Calling Support, Supplementary Services Support, HD voice (WBAMR), Emergency Calls, HSDPA 14.4 Mbps, HSUPA 5.76 Mbps, Multiple Primary PDP Contexts, Cell FACH, Basic Data Rate Adaptation, Non-Standard UE Profiling & Corrective Actions, Advanced Data Rate Adaptation (Voice Priority).

Cell Tower 152 is a site where antennas and electronic communications equipment are placed, usually on a radio mast, tower or other high place, to create a cell (or adjacent cells) in a cellular network. The elevated structure typically supports antennas, and one or more sets of transmitter/receiver transceivers, digital signal processors, control electronics, a GPS receiver for timing (for CDMA2000/IS-95 or GSM systems), primary and backup electrical power sources, and sheltering.

A cell site is sometimes called a “cell tower”, even if the cell site antennas are mounted on a building rather than a tower. In GSM networks, the technically correct term is Base Transceiver Station (BTS), and colloquial British English synonyms are “mobile phone mast” or “base station”. The term “base station site” might better reflect the increasing co-location of multiple mobile operators, and therefore multiple base stations, at a single site. Depending on an operator's technology, even a site hosting just a single mobile operator may house multiple base stations, each to serve a different air interface technology (CDMA2000 or GSM, for example).

Local Network 260 is a collection of computers and other hardware interconnected by wired and/or wireless communication channels that allow sharing of resources and information, where at least one process in one device is able transmit/receive data to/from at least one process residing in a remote device. Communication protocols define the rules and data formats for exchanging information within a computer network.

Local Network 260 may also be partially configured as a Voice over IP network (VoIP), which refers to the communication protocols, technologies, methodologies, and transmission techniques involved in the delivery of voice communications and multimedia sessions over Internet Protocol (IP) networks, such as the Internet. Other terms commonly associated with VoIP are IP telephony, Internet telephony, voice over broadband (VoBB), broadband telephony, IP communications, and broadband phone.

Internet telephony also refers to communications services, such as, but not limited to, voice, fax, SMS, and/or voice-messaging applications that are transported via the Internet, rather than the public switched telephone network (PSTN). The steps involved in originating a VoIP telephone call are signaling and media channel setup, digitization of the analog voice signal, encoding, packetization, and transmission as Internet Protocol (IP) packets over a packet-switched network. On the receiving side, similar steps (usually in the reverse order) such as reception of the IP packets, decoding of the packets and digital-to-analog conversion reproduce the original voice stream. Even though IP telephony and VoIP are used interchangeably, IP telephony refers to all use of IP protocols for voice communication by digital telephony systems, while VoIP is one technology used by IP telephony to transport phone calls.

VoIP systems employ session control protocols to control the set-up and tear-down of calls as well as audio codecs which encode speech allowing transmission over an IP network as digital audio via an audio stream. The choice of codec varies between different implementations of VoIP depending on application requirements and network bandwidth; some implementations rely on narrow-band and compressed speech, while others support high fidelity stereo codecs. Some popular codecs include u-law and a-law versions of G.711, G.722 which is a high-fidelity codec marketed as HD Voice by Polycom, a popular open source voice codec known as iLBC, a codec that only uses 8 kbit/s each way called G.729, and many others.

VoIP is now available on many cellphones, especially smartphones, and various Internet devices, to place calls or send SMS over 3G, 4G or Wi-Fi.

Internet 270 is a global system of interconnected computer networks that use the standard Internet protocol suite (TCP/IP) to serve billions of users worldwide. This network of networks consists of millions of private, public, academic, business, and government networks, that are local to global in scope, linked by a broad array of electronic, wireless and optical networking technologies. The Internet 270 carries a vast range of information resources and services. Internet 270 can be accessed via hard-wired and/or wireless networks, hard-wired networks such as, but not limited to, fiber optic networks, coax networks, hybrid fiber-coax networks, telephony-type networks, computer-type networks, virtual private-type networks, wide area-type wired networks, local area-type wired networks, metropolitan area-type wired networks, campus area-type wired networks, etc.; and/or wireless networks, such as, but not limited to, Bluetooth networks, wireless local area networks, RFID networks, Wi-Fi networks, cellular networks, WiMAX, WiLAN, mobile networks, wireless personal area networks, wireless mesh networks, ultra wide-band networks, etc.

LED Light 280 is a solid-state fixture, or luminaire, and uses light-emitting diodes (LEDs) as the lamps, or the source of the light. The LEDs involved may be devices such as, but not limited to, conventional semiconductor light-emitting diodes, organic LEDs (OLED), or polymer light-emitting diode (PLED) devices, although PLED technologies are not generally commercially available.

LED Light 280 may include optional sensors (not shown), which are devices that measure a physical quantity and convert it into a signal which can be read by an observer or by an instrument. For example, a thermocouple converts temperature to an output voltage which can be read by a voltmeter. Examples of optional sensors include, but are not limited to, microphones, carbon dioxide sensors, carbon monoxide detectors, chemical field-effect transistors, electrochemical gas sensors, holographic sensors, infrared sensors, non-dispersive infrared sensors, microwave chemistry sensors, nitrogen oxide sensor, olfactometers, optodes, oxygen sensors, pellistors, potentiometric sensors, redox electrodes, smoke detectors, zinc oxide nanorod sensors, electric current meters, electric potential, magnetic sensors, ammeters, current sensors, galvanometers, hall effect sensors, magnetic anomaly detector, magnetometers, MEMS magnetic field sensors, metal detectors, multimeters, ohmmeters, radio direction finders, voltmeters, voltage detectors, watt-hour meters, humidity sensors, air flow meters, Geiger counters, neutron detectors, photoelectric sensors, motion detectors, charge-coupled devices, calorimeters, electro-optical sensors, flame detectors, kinetic inductance detectors, LEDs as light sensors, light-addressable potentiometric sensors, Nichols radiometers, fiber optic sensors, photo-detectors, photo-diodes, photo-transistors, photoelectric sensors, photo-ionization detector, photo-multipliers, photo-resistors, photo-switches, photo-tubes, scintillometers, visible light photon counters, barometers, pressure sensors, load cells, magnetic level gauges, strain gauges, bolometers, bi-metallic strips, infrared thermometers, microbolometers, microwave radiometers, net radiometers, quartz thermometers, resistance temperature detectors, resistance thermometers, silicon bandgap temperature sensors, thermistors, thermocouples, thermometers, alarm sensors, occupancy sensors, proximity sensors, passive infrared sensors, reed switches, triangulation sensors, bio-sensors, radar, ground penetrating radar, synthetic aperture radar. These sensors may use technology such as, but not limited to, active pixel sensors, back-illuminated sensors, catadioptric sensors, carbon paste electrodes, displacement receivers, electromechanical film, electro-optical sensors, Fabry-Perot interferometers, image sensors, inductive sensors, machine vision technology. micro-electromechanical systems, micro-sensor arrays, photo-elasticity, sensor fusion, sensor grids, sensor nodes, sonar, transducers, ultrasonic sensors, video sensors, visual sensor networks, Wheatstone bridges, wireless sensor networks, frame grabbers, intensity sensors, chemo-receptors, compressive sensing, hyper-spectral sensors, millimeter wave scanners, magnetic resonance imaging, diffusion tensor imaging, functional magnetic resonance imaging, molecular sensors, etc.

LED Light 280 may integrate other devices (not shown), which can include technology such as, but not limited to, Radio Frequency Identification (RFID) readers, barcode readers, cameras, wired and wireless switches, wired and wireless routers, wired and wireless hubs, alarms, femto-cells, pico-cells, micro-cells, smart card readers, etc.

LED Light 280 may also include integrated Modified Power-over-Ethernet, as described in U.S. patent application Ser. No. 14/108,938, which is incorporated by reference in its entirety herein, capabilities, such as Modified Power Sourcing Equipment (MPSE) (not shown), which is a device, such as, but not limited to a switch. MPSE can transmit/receive data, and source power, combined on a Common Ethernet Cable 297 that feeds a Modified or Standard Powered Device (PD) not shown.

When a MPSE device is a switch, it's called an endspan in Ethernet vernacular. Otherwise, if it's an intermediary device between a non-combined low voltage power/data cabling capable switch and a combined low voltage power/data cabling device, it's called a midspan. An external combined low voltage power/data cabling injector is a midspan device.

A Modified Powered Device (MPD) or standard Powered Device (PD) is powered by PSE. Some examples of PDs include, but not limited to, wireless access points, IP Phones, IP cameras, etc.

Many types of MPDs or PDs have an auxiliary power connector for an optional, external, power supply. Depending on the MPD or PD design, some, none, or all power can be supplied from an auxiliary port, with the auxiliary port sometimes acting as backup power in case of power failure.

The Flat Panel Lighting System (FPLS) LED Light 280 is the preferred design form to integrate the present invention. The FPLS design form replaces 40+ year old fluorescent tube technology, which represents approximately 80% of the indoor lighting market.

The FPLS (LED 280) is simple to assemble, constructed of durable materials, is efficient, produces indirect lighting, and has a favorable Power Factor. Other benefits of the design form include: Sanitizable surface made with non-yellowing materials, Shatterproof lens for vandal proof applications, Indirect lighting for zero-glare and even distribution, “Zero” clearance installation and optimized packaging profile. Efficient assembly from component to completion in approximately 5 minutes.

The Flat Panel LED Light design form has been embraced by correctional facilities and educational institutions for its vandal resistant qualities. Hospitals and assisted living facilities like its full light spectrum, dimming capabilities, and zero plenum exchange. The food service industry enjoys its clean-ability, and the list continues. As a stand-alone prior art product, the FPLS is highly marketable and widely accepted.

The present invention uses a “smart” FPLS design form, and using “Modified Power-over-Ethernet” features, modular ports, and high speed data transmission over virtually any wire, the FPLS becomes a smart fixture that is an integrated part of any computer network.

Each FPLS smart fixture can be IP addressable, and include integrated modular ports for communications, sensors, cameras, RFID interrogators, etc. Communication systems that can be co-located with a FPLS fixture include, Wi-Fi, Bluetooth 4.0, cellular network femto-cells, etc. Sensors that may be plugged into a SMART fixture's ports include, motion, CO2, temperature, etc. In addition, in the back-end, the FPLS smart fixtures can be integrated with third-party software and systems, such as, smart grids, building management systems, security systems, etc.

Very inexpensive “cell-phone type” cameras can be integrated in the fixtures to provide ambient light sensing to trigger switches to turn individual lights on/off, and control dimming. They can also be used as motion detectors to drive security systems, for machine vision image capture to drive a barcode decoding engine, optical character recognition (OCR), etc.

In addition, FPLS LED Lights can be used as a core piece in the present invention's Identify Friend or Foe (IFF) electronic surveillance system. Cell phones, Bluetooth Low Energy transponders, and Wi-Fi signals can all be part of a comprehensive system to electronically detect, locate, and monitor the movement of individuals, vehicles, and assets in corporate offices, factories, warehouses, college campuses, automobile dealer lots, parking garages, etc. Femtocells (aka Microcells) (miniature cellphone towers), Bluetooth transceivers, and Wi-Fi routers can be co-located with Flat Panel LED Lights to create an extensible combined power/data network. This combined network will be capable of delivering power to flat panel LEDs' over either low or high voltage wiring, and also transmit/receive data over the same low or high voltage wiring used to power the lights.

LED Light 280 can include optional hardwire port interfaces (not shown) to transmit/receive data via standard audio, video, and computer equipment jack and ports include, but are not limited to: connectors for twisted pair cable include the modular RJ type of jacks and plugs (RJ-11; RJ-14; RJ-22; RJ-25; RJ-31; RJ-45; RJ-48; RJ-61) (of four, six, and eight position configurations) along with the hermaphroditic connector employed by IBM. The hermaphroditic connector is specific to shielded twisted pair (STP) and is also known as a STP connector, IBM data connector, or universal data connector. The connector used with patch panels, punch-down blocks, and wall plates, is called an IDC (insulated displacement connector). Modular Y-adapters used for splitting usually in 10Base-T, Token Ring, and voice applications. Also, crossover cables which are wired to a T586A pin-out scheme on one end and a T586B pin-out on the other end. Coax connectors used with video equipment are referred to as F-series connectors (primarily used in residential installations for RG-58, RG-59, and RG-6 coaxial cables). Coax cables used with data and video backbone applications use N-connectors (used with RG-8, RJ-11U, and thicknet cables). When coaxial cable distributes data in commercial environments, the BNC (Bayonet Niell-Concelman) connector is often used. It is used with RG-6, RG-58A/U thinnet, RG-59, and RG-62 coax cable. Fiber-optic connectors include SC, duplex SC, ST, duplex ST, FDDI, and FC. These relate to different types of fiber-optic cables and configurations. Three of the SFF connectors that have recently been propagated (for fiber-optic cables are LC, VF-45, and the MT-RJ, etc. Transmission Paths 190A, 190B, 190C, 190D, 190E, 190F, 190G, 190H, 190J, 190K, 190L, 190M are electrically conductive, or photonic cables capable of transmitting/receiving data.

The data being transmitted/received over a wire in the present invention can be native or encapsulated in packets in the present invention using a wide variety of protocols such as, but not limited to, MOCA, Home PNA, HomePlug Standard, tZero UltraMIMO, Modem 110 baud, Modem 300 baud (V.21), Modem Bell 103 (Bell 103), Modem 1200 (V.22), Modem Bell 212A (Bell 212A), Modem 2400 (V.22bis), Modem 9600 (V.32), Modem 14.4 k (V.32bis), Modem 19.2 k (V.32terbo), Modem 28.8 k (V.34), Modem 33.6 k (V.34plus/V.34bis), Modem 56 k (V.90), and Modem 56 k (V.92), 64 k ISDN and 128 k dual-channel ISDN, Serial RS-232, Serial RS-232 max, USB Low Speed, Parallel (Centronics), Serial RS-422 max, USB Full Speed, SCSI 1, Fast SCSI 2, FireWire (IEEE 1394) 100, Fast Wide SCSI 2, FireWire (IEEE 1394) 200, Ultra DMA ATA 33, Ultra Wide SCSI 40, FireWire (IEEE 1394) 400, USB Hi-Speed, Ultra DMA ATA 66, Ultra-2 SCSI 80, FireWire (IEEE 1394b) 800, Ultra DMA ATA 100 800, Ultra DMA ATA 133, PCI 32/33, Serial ATA (SATA-150), Ultra-3 SCSI 160, Fibre Channel, PCI 64/33, PCI 32/66, AGP 1.times., Serial ATA (SATA-300), Ultra-320 SCSI, PCI Express (.times.1 link), AGP 2x, PCI 64/66, Ultra-640 SCSI, AGP 4x, PCI-X 133, InfiniBand, PCI Express (.times.4 link), AGP 8x, PCI-X DDR, HyperTransport (800 MHz, 16-pair), PCI Express (.times.16 link), iSCSI (Internet SCSI), and HyperTransport (1 GHz, 16-pair), IrDA-Control, 802.15.4 (2.4 GHz), Bluetooth 1.1, 802.11 legacy, Bluetooth 2, RONJA free source optical wireless, 802.11b DSSS, 802.11b+ non-standard DSSS, 802.11a, 802.11g DSSS, 802.11n, 802.16 (WiBro) and 802.16 (Hiperman), GSM CSD, HSCSD, GPRS, UMTS, CDMA, TDMA, DS0, Satellite Internet, Frame Relay, G.SHDSL, SDSL, ADSL, ADSL2, ADSL2Plus, DOCSIS (Cable Modem), DS1/T1, E1, E2, E3, DS3/T3, OC1, VDSL, VDSL, VDSL2, OC3, OC12, OC48, OC192, 10 Gigabit WAN PHY, 10 Gigabit LAN PHY, OC256, and OC768, LocalTalk, ARCNET, Token Ring, (10base-X), Fast (100base-X), FDDI, and Gigabit (1000 base-X), Intelligent Transportation System Data Bus (ITSDB), MIL-STD-1553, VoIP (Voice over IP) standard signaling protocols, such as, but not limited to, H.323, Megaco H.248 Gateway Control Protocol, MGCP Media Gateway Control Protocol, RVP over IP Remote Voice Protocol Over IP Specification, SAPv2 Session Announcement Protocol SGCP, Simple Gateway Control Protocol, SIP Session Initiation Protocol, and Skinny Client Control Protocol (Cisco), VoIP (Voice over IP) standard media protocols, such as, but not limited to, DVB Digital Video Broadcasting, H.261 video stream for transport using the real-time transport, H.263 Bitstream in the Real-time Transport Protocol, RTCP RTP Control Protocol, and RTP Real-Time Transport, VoIP (Voice over IP) H.323 suite of standard protocols, such as, but not limited to, H.225 Narrow-Band Visual Telephone Services, H.225 Annex G, H.225E, H.235 Security and Authentication, H.323SET, H.245 negotiates channel usage and capabilities, H.450.1 supplementary services for H.323, H.450.2 Call Transfer supplementary service for H.323, H.450.3 Call Diversion supplementary service for H.323, H.450.4 Call Hold supplementary service, H.450.5 Call Park supplementary service, H.450.6 Call Waiting supplementary service, H.450.7 Message Waiting Indication supplementary service, H.450.8 Calling Party Name Presentation supplementary service, H.450.9 Completion of Calls to Busy subscribers supplementary Service, H.450.10 Call Offer supplementary service, H.450.11 Call Intrusion supplementary service, H.450.12 ANF-CMN supplementary service, RAS Management of registration, admission, status, T.38 IP-based Fax Service Maps, T.125 Multipoint Communication Service Protocol (MCS), VoIP (Voice over IP) SIP suite of standard protocols, such as, but not limited to, MIME (Multi-purpose Internet Mail Extension), SDP (Session Description Protocol), SIP (Session Initiation Protocol), PHY protocols including, but not limited to, LDVS—Low Voltage Differential Signaling, LVTTL—Low Voltage Transistor-Transistor Logic, LVCMOS—Low Voltage Complementary Metal Oxide Semiconductor, LVPECL—Low Voltage Positive Emitter Coupled Logic, PECL—Positive Emitter Coupled Logic, ECL—Emitter Coupled Logic, CIVIL—Current Mode Logic, CMOS—Complementary metal-oxide-semiconductor, TTL—Transistor-Transistor Logic, GTL—Gunning Transceiver Logic, GTLP—Gunning Transceiver Logic Plus, HSTL—High-Speed Transceiver Logic, SSTL—Stub Series Terminated Logic, memory chip access protocols including, but not limited to, SDR (software defined radio), DDR (double data rate), QDR (quad data rate), RS Standards protocols including, but not limited to, RS 232, RS-422-B, RS-423-B, RS-449, RS-485, RS-530, RS 561, RS-562, RS 574, RS-612, RS 613, V-standards protocols including, but not limited to, V.10, V.11, V.24, V.28, V.35, (MAC-PHY) protocols including, but not limited to, XGMII, RGMII, SGMII, GMII, MII, TBI, RTBI, AUI, XAUI, PCB Level Control protocols including, but not limited to, SPI, I.sup.2C, MDIO, JTAG, fiber optic protocols including, but not limited to, SDH, CWDM, DWDM, back-plane protocols including, but not limited to, VMEbus, PC 104A, ATCA, SBus, and other protocols, such as, but not limited to, GFP, Actel and Atmel ARM Microprocessor buses including, but not limited to, Advanced Microcontroller Bus Architecture (AMBA), Advanced High performance Bus (AHB), Xilinx Microblaze microprocessor buses including, but not limited to, Fast Simplex Link (FSL), On-chip Peripheral Bus (OPB), Local Memory Bus (LMB), and Xilinx PowerPC microprocessor buses including, but not limited to, On-chip Peripheral. Bus (OPB), Processor Local Bus (PLB), Device Control Register (DCR) bus, Altera Nios II microprocessor bus including, but not limited to, Avalon Interface, and Latice LatticeMicro32 open IP microprocessor 1core bus including, but not limited to, Wishbone, etc.

Transmission Paths 295A, 295B, 295C, 295D, 295E, 295F, 295G, 295H can be designed to transmit/receive data wirelessly using radio frequency, or free space optics.

Data being transmitted/received wirelessly in the present invention can be native or encapsulated in packets in the present invention using a wide variety of protocols such as, but not limited to, MOCA, Home PNA, HomePlug Standard, tZero UltraMIMO, Modem 110 baud, Modem 300 baud (V.21), Modem Bell 103 (Bell 103), Modem 1200 (V.22), Modem Bell 212A (Bell 212A), Modem 2400 (V.22bis), Modem 9600 (V.32), Modem 14.4 k (V.32bis), Modem 19.2 k (V.32terbo), Modem 28.8 k (V.34), Modem 33.6 k (V.34plus/V.34bis), Modem 56 k (V.90), and Modem 56 k (V.92), 64 k ISDN and 128 k dual-channel ISDN, Serial RS-232, Serial RS-232 max, USB Low Speed, Parallel (Centronics), Serial RS-422 max, USB Full Speed, SCSI 1, Fast SCSI 2, FireWire (IEEE 1394) 100, Fast Wide SCSI 2, FireWire (IEEE 1394) 200, Ultra DMA ATA 33, Ultra Wide SCSI 40, FireWire (IEEE 1394) 400, USB Hi-Speed, Ultra DMA ATA 66, Ultra-2 SCSI 80, FireWire (IEEE 1394b) 800, Ultra DMA ATA 100 800, Ultra DMA ATA 133, PCI 32/33, Serial ATA (SATA-150), Ultra-3 SCSI 160, Fibre Channel, PCI 64/33, PCI 32/66, AGP 1x, Serial ATA (SATA-300), Ultra-320 SCSI, PCI Express (.times.1 link), AGP 2x, PCI 64/66, Ultra-640 SCSI, AGP 4x, PCI-X 133, InfiniBand, PCI Express (.times.4 link), AGP 8x, PCI-X DDR, HyperTransport (800 MHz, 16-pair), PCI Express (.times.16 link), iSCSI (Internet SCSI), and HyperTransport (1 GHz, 16-pair), IrDA-Control, 802.15.4 (2.4 GHz), Bluetooth 1.1, 802.11 legacy, Bluetooth 2, RONJA free source optical wireless, 802.11b DSSS, 802.11b+ non-standard DSSS, 802.11a, 802.11g DSSS, 802.11n, 802.16 (WiBro) and 802.16 (Hiperman), GSM CSD, HSCSD, GPRS, UMTS, CDMA, TDMA, DS0, Satellite Internet, Frame Relay, G.SHDSL, SDSL, ADSL, ADSL2, ADSL2Plus, DOCSIS (Cable Modem), DS1/T1, E1, E2, E3, DS3/T3, OC1, VDSL, VDSL, VDSL2, OC3, OC12, OC48, OC192, 10 Gigabit WAN PHY, 10 Gigabit LAN PHY, OC256, and OC768, LocalTalk, ARCNET, Token Ring, (10base-X), Fast (100base-X), FDDI, and Gigabit (1000 base-X), Intelligent Transportation System Data Bus (ITSDB), MIL-STD-1553, VoIP (Voice over IP) standard signaling protocols, such as, but not limited to, H.323, Megaco H.248 Gateway Control Protocol, MGCP Media Gateway Control Protocol, RVP over IP Remote Voice Protocol Over IP Specification, SAPv2 Session Announcement Protocol SGCP, Simple Gateway Control Protocol, SIP Session Initiation Protocol, and Skinny Client Control Protocol (Cisco), VoIP (Voice over IP) standard media protocols, such as, but not limited to, DVB Digital Video Broadcasting, H.261 video stream for transport using the real-time transport, H.263 Bitstream in the Real-time Transport Protocol, RTCP RTP Control Protocol, and RTP Real-Time Transport, VoIP (Voice over IP) H.323 suite of standard protocols, such as, but not limited to, H.225 Narrow-Band Visual Telephone Services, H.225 Annex G, H.225E, H.235 Security and Authentication, H.323 SET, H.245 negotiates channel usage and capabilities, H.450.1 supplementary services for H.323, H.450.2 Call Transfer supplementary service for H.323, H.450.3 Call Diversion supplementary service for H.323, H.450.4 Call Hold supplementary service, H.450.5 Call Park supplementary service, H.450.6 Call Waiting supplementary service, H.450.7 Message Waiting Indication supplementary service, H.450.8 Calling Party Name Presentation supplementary service, H.450.9 Completion of Calls to Busy subscribers supplementary Service, H.450.10 Call Offer supplementary service, H.450.11 Call Intrusion supplementary service, H.450.12 ANF-CMN supplementary service, RAS Management of registration, admission, status, T.38 IP-based Fax Service Maps, T.125 Multipoint Communication Service Protocol (MCS), VoIP (Voice over IP) SIP suite of standard protocols, such as, but not limited to, MIME (Multi-purpose Internet Mail Extension), SDP (Session Description Protocol), SIP (Session Initiation Protocol), PHY protocols including, but not limited to, LDVS—Low Voltage Differential Signaling, LVTTL—Low Voltage Transistor-Transistor Logic, LVCMOS—Low Voltage Complementary Metal Oxide Semiconductor, LVPECL—Low Voltage Positive Emitter Coupled Logic, PECL—Positive Emitter Coupled Logic, ECL—Emitter Coupled Logic, CIVIL—Current Mode Logic, CMOS—Complementary metal-oxide-semiconductor, TTL—Transistor-Transistor Logic, GTL—Gunning Transceiver Logic, GTLP—Gunning Transceiver Logic Plus, HSTL—High-Speed Transceiver Logic, SSTL—Stub Series Terminated Logic, memory chip access protocols including, but not limited to, SDR (software defined radio), DDR (double data rate), QDR (quad data rate), RS Standards protocols including, but not limited to, RS 232, RS-422-B, RS-423-B, RS-449, RS-485, RS-530, RS 561, RS-562, RS 574, RS-612, RS 613, V-standards protocols including, but not limited to, V.10, V.11, V.24, V.28, V.35, (MAC-PHY) protocols including, but not limited to, XGMII, RGMII, SGMII, GMII, MII, TBI, RTBI, AUI, XAUI, PCB Level Control protocols including, but not limited to, SPI, I.sup.2C, MDIO, JTAG, fiber optic protocols including, but not limited to, SDH, CWDM, DWDM, back-plane protocols including, but not limited to, VMEbus, PC 104A, ATCA, SBus, and other protocols, such as, but not limited to, GFP, Actel and Atmel ARM Microprocessor buses including, but not limited to, Advanced Microcontroller Bus Architecture (AMBA), Advanced High performance Bus (AHB), Xilinx Microblaze microprocessor buses including, but not limited to, Fast Simplex Link (FSL), On-chip Peripheral Bus (OPB), Local Memory Bus (LMB), and Xilinx PowerPC microprocessor buses including, but not limited to, On-chip Peripheral. Bus (OPB), Processor Local Bus (PLB), Device Control Register (DCR) bus, Altera Nios II microprocessor bus including, but not limited to, Avalon Interface, and Latice LatticeMicro32 open IP microprocessor core bus including, but not limited to, Wishbone, etc.

Line-of-Sight Image Acquisition Paths 299A, 299B, 299C are electromagnetic transmission paths, which depicts light emissions from an object traveling in a straight line. The rays or waves may be diffracted, refracted, reflected, or absorbed by atmosphere and obstructions with material and generally, and cannot travel over the horizon or behind obstacles.

FIG. 4 is an illustration of an optional transponder configured for use within the present invention. BLE XPNDER 300 is designed to be inserted into a port on cell phone 240 (as shown in FIG. 3). BLE XPNDR 300 consists of the following components, processor 310, memory 320, radio 330, antenna 340, and port 350. Processor 310 incorporates the functions of a central processing unit (CPU) on at least one integrated circuit. Processor 310 accepts digital data as input, processes it according to instructions stored in memory 320, and provides results as output. Memory 320 is a physical device used to store programs (sequences of instructions) or data (e.g. program state information) on a temporary or permanent basis. Memory 320 is connected to processor 310, radio 330 and port 350.

Radio 330 is a wireless transmission device used for transmitting and receiving BLE signals via antenna 340 through free space by electromagnetic radiation of a frequency significantly below that of visible light, in the radio frequency range, from about 30 kHz to 300 GHz, which are commonly known as radio waves. Information is carried by systematically changing (modulating) some property of the radiated waves, such as, but is not limited to amplitude, frequency, phase, or pulse width. When radio waves strike an electrical conductor, the oscillating fields induce an alternating current in the conductor. The information in the radio waves can be extracted and transformed back into its original form. Alternatively to BLE, radio 330 can be configured to operate according to at least one Wireless Protocol, such as, but is not limited to, MiWi, Wi-Max, CDMA, TDMA, RFID, Satellite, etc, to achieve the goals of the present invention.

Antenna 340 is an electrical device configured to transmit/receive BLE signals. Antenna 340 converts electric power into radio waves, and vice versa. It is usually used with a radio transmitter or radio receiver. In transmission, a radio transmitter supplies an oscillating radio frequency electric current to the antenna's terminals, and the antenna radiates the energy from the current as electromagnetic waves (radio waves). In reception, an antenna intercepts some of the power of an electromagnetic wave in order to produce a tiny voltage at its terminals that is applied to a receiver to be amplified. Alternatively to BLE, antenna 340 can be configured transmit and receive signals according to at least one protocol, such as, but is not limited to, MiWi, Wi-Max, CDMA, TDMA, RFID, Satellite, etc, to achieve the goals of the present invention.

Port 350 is an electro-mechanical device for joining electrical and/or data circuits as an interface using a mechanical assembly. Only one port 350 is shown in FIG. 4 for clarity, but BLE XPNDR 300 may include additional port 350s. Port 350 can be designed to plug into a port (not shown) on cellphone 240 as illustrated in FIG. 3, in order to transmit/receive data from cellphone 240, or in conjunction with cellphone 240, for identification, authentication, permission, surveillance, or other purposes. The location of BLE XPNDR 300 can be determined within a hybrid positioning system using a network of Wi-Fi 210A, 210B, as illustrated in FIG. 3, and/or a network of BLE WAP 230, as illustrated in FIG. 3, and/or a network of Micro Cells 251, as illustrated in FIG. 3, or by cell tower 252 ID, as illustrated in FIG. 3, and/or a network of MiWi WAP (not shown), or directly from the host cellphone 240, as illustrated in FIG. 3.

BLE XPNDER 300 is also enabled with a mag-stripe reader (not shown) that is capable of reading mag-stripe 232, as illustrated in FIG. 3.

### Practical Implementation of the Present Invention

The following example describes the present invention used in a fast-food restaurant, which includes a drive-thru. When a vehicle drives up to an outdoor order station, a camera records the image of the license plate, to coordinate vehicle information with passenger(s)/customer(s) orders. A database and app running in the background store the license plate, and passenger(s)/customer(s) orders, in order to build a set of preferences to better serve the passenger(s)/customer(s) in the future, or offer discounts or coupons on their next visit, etc. When a customer walks up to indoor order station, a camera records the image of the customer's face to coordinate their face with their order. A database and app running in the background store the face image, in order to build a set of preferences to better serve the customer in the future, or offer discounts or coupons on their next visit, etc.

RFID interrogators track employee badges, assets, inventory, etc. The RFID interrogators are linked to a database and app running in the background to store the electronic identification numbers associated with RFID tags. As an example, all the employee badges with RFID tags are found to be located in the restaurants cooler, or freezer, it might be deduced that a robbery is taking place. The employee badges with RFID tags can also be used to record time and attendance information related to payroll activities.

Microcells attached to a self-contained IP telephony network, sniff electronic identification numbers associated with cellphones within range. The IP telephony network is linked to a database and app running in the background to store the electronic identification numbers, in order to build a database of potential friends or foes within the operating range of the microcells. Employee electronic identification numbers associated with a cellphone can be registered with the system, in order to record time and attendance information related to payroll activities. Repeat customer's electronic identification numbers associated with a cellphone can be recorded in order to send a text message or email that includes a discount, or coupon, as a registered customer drives by, or enters the parking lot, or enters the restaurant. The IP telephony system can be used to complete calls for employees, and connect them to the Internet as a means of ensuring the employee is not making phone calls, or connecting to the Internet during designated work time.

Employee badges with magnetic strips can be used to gain access to areas secured with magnetic stripe readers, such as a freezer or cooler, or activate time clocks, or log on to computers and networks, etc.

The BLE Bluetooth Transponder can be used as a secondary form of electronic identification in conjunction with RFID, cellphones, or stand-alone to identify employees, assets, inventory etc. As an example, on a college campus, a BLE Bluetooth Transponder can be paired with a cellphone, in order to more positively identify college students, employees, professors, registered guests for various events, registered guests that are performing maintenance or construction activities, etc.

The present invention has been described in particular detail with respect to several possible embodiments. Those of skill in the art may appreciate that the invention may be practiced in other embodiments. First, the particular naming of the components and capitalization of terms is not mandatory or significant, and the mechanisms that implement the invention or its features may have different names, formats, or protocols. Also, the particular division of functionality between the various systems components described herein is merely exemplary, and not mandatory. Functions performed by a single system component may instead be performed by multiple components, and functions performed by multiple components may instead performed by a single component.

Unless specifically stated otherwise as apparent from the above discussion, it is appreciated that throughout the description, discussions utilizing terms such as “determining” or the like, refer to the action and processes of a computer system, or similar electronic computing device, that manipulates and transforms data represented as physical (electronic) quantities within the computer system memories or registers or other such information storage devices. Certain aspects of the present invention include process steps and instructions. It should be noted that the process steps and instructions of the present invention could be embodied in software, firmware or hardware, and when embodied in software, could be downloaded to reside on and be operated from different platforms.

Furthermore, the computers referred to in the specification may include a single processor or may be architectures employing multiple processor designs for increased computing capability. The scope of this invention should be determined by the appended claims and their legal equivalents, rather than by the examples given.

What is claimed is:

1. A system for powering and controlling light-emitting diode (LED) lighting network, the system comprising:
a non-linear dimmer matrix configured to supply an amount of electrical power to an LED fixture comprising a plurality of LED lights;
a plurality of stacked channels configured to provide the electrical power to the LED fixture at a low pulse width modulation duty cycle setting;
a plurality of power-over-Ethernet ports using a time division multiplexing scheme; and
a controller configured to receive power from the plurality of power-over-Ethernet ports and control the non-linear dimmer matrix.

2. The system of claim 1 further comprising a power station configured to aggregate power from the plurality of power-over-Ethernet ports.

3. The system of claim 2 wherein the power station is configured to permit a plurality of adjacent ports to operate on a common power bus; wherein the plurality of stacked channels is configured to permit the plurality of LED lights to operate on a singular output port.

4. The system of claim 2 wherein the power station regulates and distributes the electrical across more than one of the plurality of stacked channels; wherein the power station is modular and reconfigurable for a variety of port configurations.

5. The system of claim 1 wherein the LED fixture is configured in a daisy chain.

6. The system of claim 1 further comprising:
an ambient light sensor operably connected to the non-linear dimmer matrix and the controller; and
wherein the controller is configured to receive ambient light levels from the ambient light sensor and adjust the non-linear dimmer matrix based, at least in part, on desired dimmer settings stored in a memory.

7. The system of claim 1 further comprising:
a router and a wireless access point each operably connected to the plurality of power-over-Ethernet ports and the controller; and
wherein the power-over-Ethernet ports, the router, and the wireless access point are configured to power the LED lighting network.

8. The system of claim 1 wherein the time division multiplexing scheme sequences and offsets start times of the low pulse width modulation duty cycle setting.

9. The system of claim 1 further comprising:
shared memory operably connected to the controller and configured to store characteristics associated with the LED lighting system, wherein the stored characteristics include one of identity, building type, LED fixture operating conditions, motion measurements, lighting measurements, time, optical recognition, and magnetic swipe access; and
wherein the controller controls one of a marketing system or electronic security features based, at least in part, on the stored characteristics.

10. A method for powering and controlling light-emitting diode (LED) lighting network with a space, the method comprising the steps of:
providing a non-linear dimmer matrix, a plurality of LED fixtures each having a plurality of LED lights, a plurality of channels each configured to distribute power, a controller, and a power-over-Ethernet port;
selecting a pulse width modulation duty cycle setting based, at least in part, on stored operating instructions;
supplying with the non-linear dimmer matrix an amount of electrical power to the plurality of LED fixtures based;
powering the non-linear dimmer matrix with the power-over-Ethernet port; and
controlling the non-linear dimmer matrix with the controller.

11. The method of claim 10 further comprising the step of stacking the plurality of channels to drive each of the plurality of LED fixtures.

12. The method of claim 10 further comprising the step of selecting one of the plurality of channels to distribute power to each of the plurality of LED fixtures.

13. The method of claim 11 further comprising the step of operating each of the stacked plurality of channels at the pulse width modulation duty cycle setting in a range of 0.300 to 0.400.

14. The method of claim 10 further comprising the step of power the plurality of LED fixtures with a single power-over-Ethernet port with a time division multiplexing scheme.

15. The method of claim 10 further comprising the step of staggering and offsetting start times of the pulse width modulation duty cycle setting for each of the plurality of LED fixtures.

16. The method of claim 10 further comprising the step of collecting data regarding the space with a plurality of sensors.

17. The method of claim 16 further comprising the step of detecting ambient light conditions within the space using at least one of the plurality of sensors.

18. The method of claim 16 further comprising the step of providing marketing material via a marketing system operably connected to the LED lighting network based, at least in part, on the collected data.

19. The method of claim 16 further comprising the step of controlling security features associated with the LED lighting network based, at least in part, on the collected data.

20. The method of claim 12 further comprising the step of conditioning the power supplied by the power-over-Ethernet port without requiring a DC power supply or drive.
